(19) United States
(12) Patent Application Publication
(10) Pub. No.: US 2025/0373179 A1
(43) Pub. Date: Dec. 4, 2025

(54) POWER CONVERSION DEVICE AND PROGRAM PRODUCT

(71) Applicant: Denso Corporation, Kariya-city (JP)

(72) Inventors: Yuji ITO, Nisshin-city (JP); Kenji Ochi, Kariya-city (JP); Kwanryul Kim, Kariya-city (JP); Kimikazu Nakamura, Kariya-city (JP)

(73) Assignee: Denso Corporation, Kariya-city (JP)

(21) Appl. No.: 19/246,057

(22) Filed: Jun. 23, 2025

Related U.S. Application Data
(63) Continuation of application No. PCT/JP2023/042913, filed on Nov. 30, 2023.

(30) Foreign Application Priority Data
Dec. 21, 2022 (JP) 2022-204730

(51) Int. Cl. H02M 7/797; B60L 53/20; B60L 55/00; H02M 1/00; H02M 1/14; H02M 3/158; H02M 3/335

(52) U.S. Cl. CPC H02M 7/797; B60L 53/20; B60L 55/00; H02M 1/007; H02M 1/14; H02M 3/1582; H02M 3/33515; H02M 3/33573; H02M 3/33584; H02M 3/33592; B60L 2210/30; B60L 2210/42

(57) ABSTRACT

In a power conversion device, a high-side terminal of a fourth upper arm switch is connected to a high-side path, and a low-side terminal of the fourth lower arm switch is connected to a low-side path. A connection path is arranged to connect between a connection point between the fourth upper and lower arm switches and a fourth AC terminal. A first terminal of a compensating power storage unit is connected to a portion of a third path through a compensating switch. The portion of the third path is located closer to a third AC terminal than a third inductor is. A second terminal of the compensating power storage unit is connected to one of the low-side path and the high-side path. A connection point between the compensating power storage unit and the compensating switch is connected in parallel to the other of the low-side path and the high-side path.

### CROSS-REFERENCE TO RELATED APPLICATION

The present application is a bypass continuation application of currently pending international application No. PCT/JP2023/042913 filed on Nov. 30, 2023 designating the United States of America, the entire disclosure of which is incorporated herein by reference, the international application being based on and claims the benefit of priority from earlier Japanese Patent Application No. 2022-204730 filed on Dec. 21, 2022, the description of which is incorporated herein by reference.

### TECHNICAL FIELD

The present disclosure relates to power conversion devices and program products.

### BACKGROUND

U.S. Pat. No. 8,503,208 discloses, as one of known power conversion devices, a power conversion device compatible with both of a three-phase alternating-current (AC) power supply and a single-phase AC power supply.

The power conversion device includes upper and lower arm switches provided for each of the three phases. A high-potential terminal of the upper arm switch of each phase is connected to a high-potential direct-current (DC) terminal, and a low-potential terminal of the lower arm switch of each phase is connected to a low-potential DC terminal.

A high-potential path and a low-potential path are connected by a DC side capacitor.

The power conversion device includes inductors provided for the respective phases and a compensating capacitor and a selector switch provided for a selected one phase from the three phases. Switching operations of the selector switch enable the compensating capacitor to be connected in parallel to the series connection of the inductor and the lower arm switch for the selected one phase or to be disconnected from the series connection.

When the single-phase AC power supply is electrically connected to AC terminals serving as an input side of the power conversion device, the selector switch is operated so that the compensating capacitor is connected in parallel to the series connection of the inductor and the lower arm switch for the selected one phase. In this parallel connection state, switching control of the upper and lower arm switches of the selected one phase results in AC power inputted from the AC terminals to the power conversion apparatus being converted into DC power with ripple in the DC power being low. The DC power with low ripple is outputted from DC terminals of the power conversion device. This enables the capacitance of the DC side capacitor to decrease, resulting in the DC side capacitor decreasing in size.

### SUMMARY

When the three-phase AC power supply is electrically connected to the AC terminals, the selector switch is operated so that the compensating capacitor is disconnected from the series connection of the series connection of the inductor and the lower arm switch for the selected one phase. Because the compensating capacitor is disconnected from the series connection of the series connection of the inductor and the lower arm switch for the selected one phase, the compensating capacitor cannot be used to reduce ripple in DC power outputted from the DC power conversion device. This may result in a need for an increase in the capacitance of the DC side capacitor, resulting in an increase in the size of the power conversion device may increase.

In view of the above circumstances, the present disclosure seeks to provide power conversion devices, each of which has a smaller size. An exemplary aspect of the present disclosure provides a power conversion device. The power conversion includes multiphase AC terminals and a pair of a high-side DC terminal and a low-side DC terminal. The power conversion device is configured such that one of a multiphase AC unit for supplying multiphase alternating currents and a single-phase AC unit for supplying a single-phase alternating current is connectable to at least one of the multiphase AC terminals.

The power conversion device includes upper and lower arm switches provided for each phase and connected to one another. The upper arm switch has a high-side terminal, and the lower arm switch has a low-side terminal. The power conversion device includes a high-side path connecting the high-side terminal of each upper arm switch and the high-side DC terminal, a low-side path connecting the low-side terminal of each lower arm switch and the low-side DC terminal, and a DC side power storage unit connecting the high-side path and the low-side path.

The power conversion device includes electric paths provided for the respective phases. Each of the electric paths is arranged to connect between a connection point of the upper and lower arm switches of the corresponding phase and the AC terminal of the corresponding phase.

The power conversion device includes inductors, each of which is provided to the corresponding one of the electric paths, and a compensating power storage unit configured to, when the single-phase AC unit is connected to at least one of the multiphase AC terminals, reduce ripple in a direct current outputted from the high- and low-side DC terminals.

The power conversion device includes a bypass switch configured to select whether the compensating power storage unit is connected in parallel to the DC side power storage unit.

Specifically, the power conversion device according to the exemplary aspect of the present disclosure includes the bypass switch configured to select whether the compensating power storage unit is connected in parallel to the DC side power storage unit.

When the multiphase AC unit is connected to at least one of the multiphase AC terminals, the bypass switch is operated to cause the compensating power storage unit to be connected in parallel to the DC side power storage unit. This enables the compensating power storage unit, which serves to reduce DC power ripple upon the single-phase AC unit is connected to at least one of the multiphase AC terminals, to additionally serve as a smoothing capacitor.

This therefore makes it possible to suppress an increase in the capacitance of the DC side power storage unit, thus preventing an increase in the size of the DC power storage unit.

### BRIEF DESCRIPTION OF THE DRAWINGS

The above object, other objects, characteristics, and advantageous benefits of the present disclosure will become apparent from the following description with reference to the accompanying drawings in which:

FIG. 1 is a diagram illustrating an overall configuration of an in-vehicle charger according to a first embodiment;

FIG. 2 is a diagram illustrating an example of first and second DC-DC converters;

FIG. 3 is a flowchart illustrating a charging/discharging control routine for a storage battery according to the first embodiment;

FIG. 4 is a diagram illustrating the in-vehicle charger as configured to operate in a three-phase charging mode or a three-phase discharging mode;

FIG. 5 is a diagram illustrating the in-vehicle charger as configured to operate in a single-phase charging mode or a single-phase discharging mode;

FIG. 6 is a block diagram of a control device as configured to perform a three-phase charging control process;

FIG. 7 is a block diagram of the control device as configured to perform a three-phase discharging control process;

FIG. 8 is a block diagram of the control device as configured to perform a single-phase charging control process;

FIG. 9 is a block diagram of the control device as configured to perform a single-phase discharging control process;

FIG. 10 is a timing chart illustrating changes of current, voltage, and the like during single-phase charging control;

FIG. 11 is a timing chart illustrating advantageous effects of improving current imbalance;

FIG. 12 is a diagram illustrating an example of effects of reducing the size of each capacitor;

FIG. 13 is a flowchart illustrating a charging/discharging control routine for the storage battery according to a second embodiment

FIG. 14 is a diagram illustrating an overall configuration of an in-vehicle charger according to a third embodiment;

FIG. 15 is a diagram illustrating an overall configuration of an in-vehicle charger according to a fourth embodiment;

FIG. 16 is a flowchart illustrating a charging/discharging control routine for the storage battery according to the fourth embodiment;

FIG. 17 is a diagram illustrating an overall configuration of an in-vehicle charger according to a fifth embodiment;

FIG. 18 is a flowchart illustrating a charging/discharging control routine for the storage battery according to the fifth embodiment;

FIG. 19 is a diagram illustrating the in-vehicle charger as configured to operate in the single-phase charging mode or the single-phase discharging mode according to the fifth embodiment;

FIG. 20 is a diagram illustrating the in-vehicle charger as configured to operate in the three-phase charging mode or the three-phase discharging mode according to the fifth embodiment;

FIG. 21 is a diagram illustrating an overall configuration of an in-vehicle charger according to a modification of the configuration of the in-vehicle charger illustrated in FIGS. 17; and

FIG. 22 is a diagram illustrating an overall configuration of an in-vehicle charger according to another modification of the configuration of the in-vehicle charger illustrated in FIG. 17.

### DETAILED DESCRIPTION OF THE PREFERRED EMBODIMENTS

With reference to the drawings, a plurality of embodiments will be described. In the plurality of embodiments, parts functionally and/or structurally corresponding to each other and/or parts associated with each other may be denoted by the same reference sign or reference signs whose hundreds or higher digits are different from each other. Regarding the corresponding parts and/or the associated parts, descriptions of other embodiments can be referred to.

### First Embodiment

Hereinafter, a first embodiment embodying a power conversion device 10 according to the present disclosure will be described with reference to the drawings. The power conversion device according to the present embodiment is provided to a vehicle such as an electric vehicle, and serves specifically as an AC-DC converter constituting a part of an in-vehicle charger. The in-vehicle charger is also referred to as an on-board charger.

The power conversion device 10 includes AC terminals and DC terminals. The power conversion device 10 includes a function of converting AC power, which is input through the AC terminals connected to an AC power supply provided outside the vehicle, to DC power and outputting the DC power from the DC terminals. The DC power output from the DC terminals is supplied to a storage battery provided to the vehicle.

In addition, the power conversion device 10 includes a function of converting the DC power, which is input from the DC terminals, to AC power and outputting the AC power from the AC terminals. The AC power output from the AC terminals is supplied to an external power system through the external AC power supply. The power conversion device 10 can be connected to a three-phase AC power supply or a single-phase AC power supply.

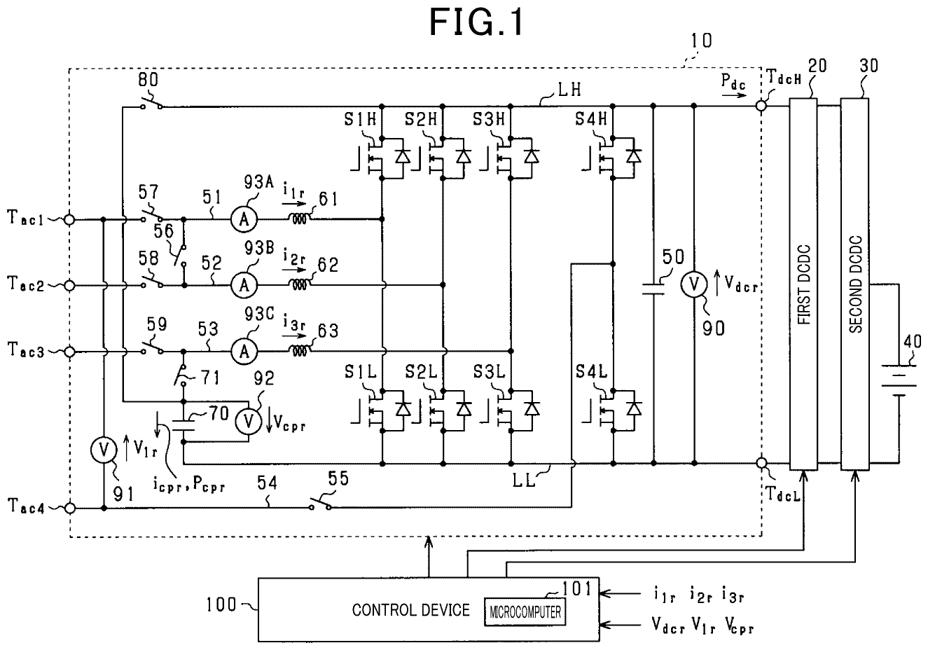

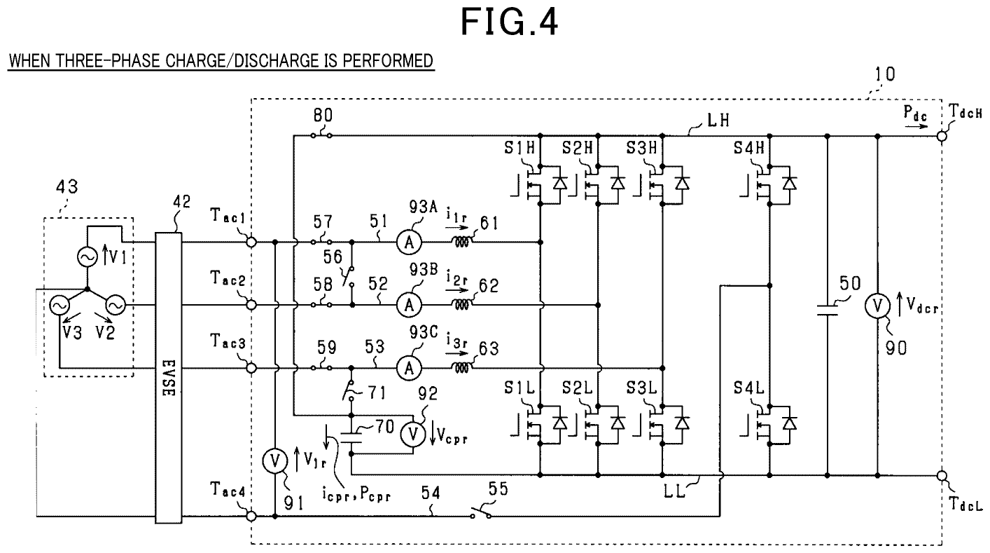

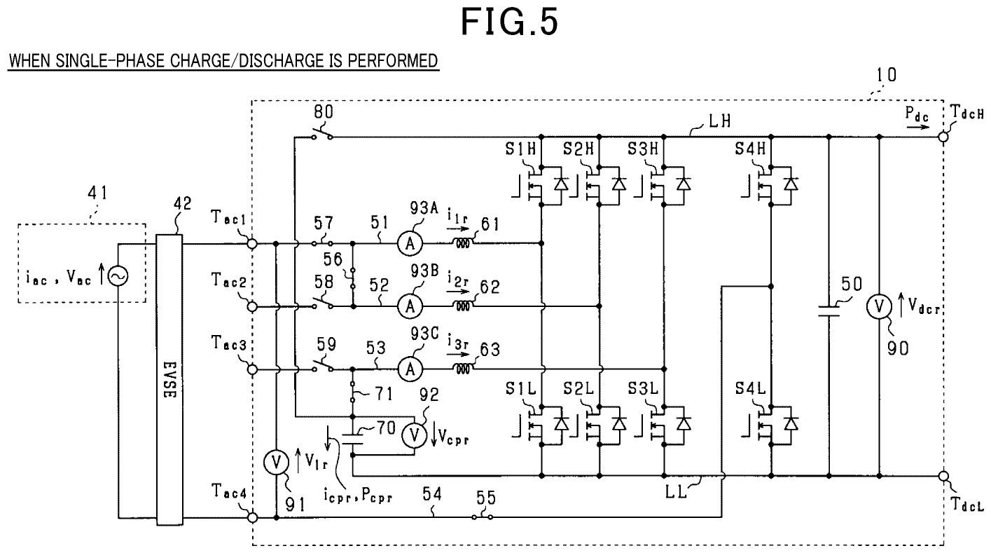

As illustrated in FIG. 1, the power conversion device 10 includes, as the AC terminals, a first AC terminal Tac1, a second AC terminal Tac2, a third AC terminal Tac3, and a fourth AC terminal Tac4. Out of the first to fourth AC terminals Tac1 to Tac4, the first to third AC terminals Tac1 to Tac3 can be, as illustrated in FIG. 4, connected to an external three-phase AC power supply 43. Out of the first to fourth AC terminals Tac1 to Tac4, the first and fourth AC terminals Tac1, Tac4 can be, as illustrated in FIG. 5, connected to an external single-phase AC power supply 41.

The power conversion device 10 includes, as the DC terminals, a high-potential side DC terminal TdcH and a low-potential side DC terminal TdcL. The high-potential side DC terminal TdcH and the low-potential side DC terminal TdcL are connected to a first DC-DC converter 20 constituting a part of the in-vehicle charger. The first DC-DC converter 20 is connected to a second DC-DC converter 30 constituting the in-vehicle charger. The second DC-DC converter 30 is connected to a chargeable and dischargeable storage battery 40 mounted to the vehicle.

The first DC-DC converter 20 transforms DC voltage input from the high-potential side DC terminal TdcH and the low-potential side DC terminal TdcL and outputs the transformed DC voltage to the second DC-DC converter 30. In addition, the first DC-DC converter 20 transforms DC voltage input from the second DC-DC converter 30 and outputs the transformed DC voltage to the high-potential side DC terminal TdcH and the low-potential side DC terminal TdcL.

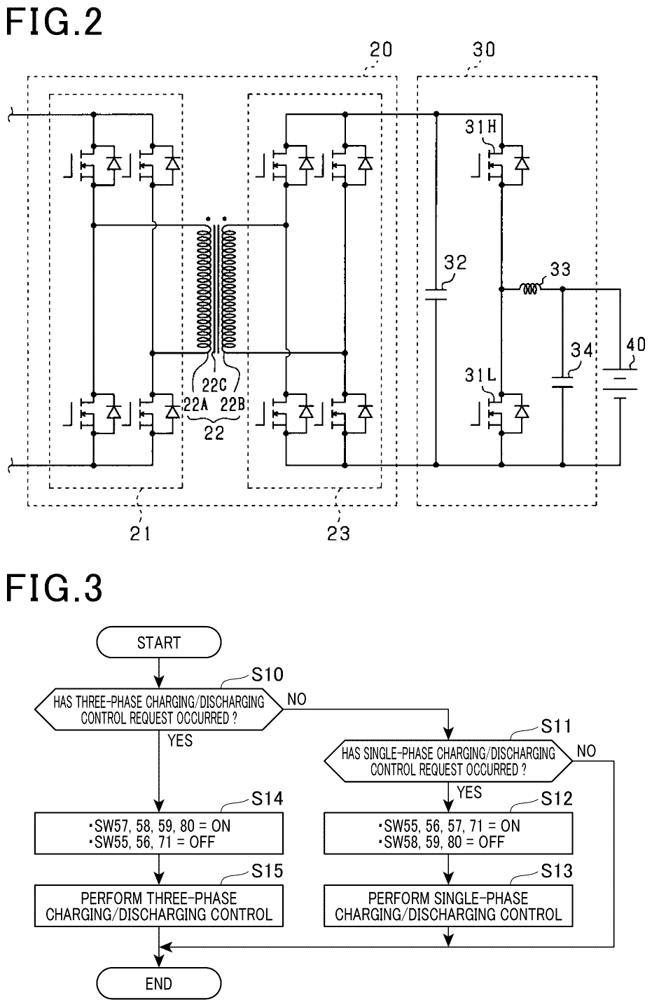

The first DC-DC converter 20 is, for example, as illustrated FIG. 2, an insulated DC-DC converter. In the example illustrated in FIG. 2, the first DC-DC converter 20 has a DAB (Dual Active Bridge) system, and includes a first full-bridge circuit 21, a second full-bridge circuit 23, and a transformer 22 that transfers power between the full-bridge circuits 21 and 23.

The transformer 22 includes a first coil 22A connected to the first full-bridge circuit 21, a second coil 22B connected to the second full-bridge circuit 23, and a core 22C that is magnetically coupled to the coils 22A, 22B. It is noted that the first DC-DC converter 20 may have another system (e.g., an LLC system).

In the example illustrated in FIG. 2, the second DC-DC converter 30 includes upper and lower arm transformation switches 31H and 31L, a first capacitor 32, an inductor 33, and a second capacitor 34. The second DC-DC converter 30 steps down DC voltage input from the first DC-DC converter 20 and outputs the stepped-down DC voltage to the storage battery 40. In addition, the second DC-DC converter 30 steps up DC voltage input from the storage battery 40 and outputs the stepped-up DC voltage to the second DC-DC converter 30.

Returning to FIG. 1, the power conversion device 10 includes, as upper and lower arm switches for four phases, a first series connection of a first upper arm switch S1H and a first lower arm switch S1L, a second series connection of a second upper arm switch S2H and a second lower arm switch S2L, a third series connection of a third upper arm switch S3H and a third lower arm switch S3L, and a fourth series connection of a fourth upper arm switch S4H and a fourth lower arm switch S4L. In the present embodiment, each of the upper and lower arm switches S1H to S4L is an N-channel MOSFET having an intrinsic diode. That is, the high-potential side terminal of each switch S1H to S4L serves as a drain, and the low-potential side terminal of each switch S1H to S4L serves as a source. The first phase serves as a U-phase, the second phase serves as a V-phase, and the third phase serves as a W-phase.

The power conversion device 10 includes a high-potential side path LH that is an electric path connecting between (i) the high-potential side terminals of the first, second, third, and fourth upper arm switches S1H, S2H, S3H, S4H and (ii) the high-potential side DC terminal TdcH. The power conversion device 10 includes a low-potential side path LL that is an electric path connecting between (i) the low-potential side terminals of the first, second, third, and fourth lower arm switches S1L, S2L, S3L, S4L and (ii) the low-potential side DC terminal TdcL. Each of the high-potential side path LH and the low-potential side path LL is comprised of a conductive members such as a bus bar.

The power conversion device 10 includes a DC side capacitor 50 (corresponding to a DC side power storage unit) connecting the high-potential side path LH and the low-potential side path LL. The DC side capacitor 50 functions as a smoothing capacitor and is, for example, an electrolytic capacitor.

The power conversion device 10 includes a first path 51, a second path 52, and a third path 53.

The first path 51 is an electric path connecting between (i) the low-potential side terminal of the first upper arm switch S1H and the high-potential side terminal of the first lower arm switch S1L and (ii) the first AC terminal Tac1.

The second path 52 is an electric path connecting between (i) the low-potential side terminal of the second upper arm switch S2H and the high-potential side terminal of the second lower arm switch S2L and (ii) the second AC terminal Tac2.

The third path 53 is an electric path connecting between (i) the low-potential side terminal of the third upper arm switch S3H and the high-potential side terminal of the third lower arm switch S3L and (ii) the third AC terminal Tac3.

The power conversion device 10 includes a first inductor 61 provided to the first path 51, a second inductor 62 provided to the second path 52, and a third inductor 63 provided to the third path 53. It is noted that the inductors 61 to 63 may have a predetermined inductance value, and/or may have a predetermined rated current based on allowable temperature rise.

The power conversion device 10 includes a connection path 54 that is an electric path connecting between (i) the low-potential side terminal of the fourth upper arm switch S4H and the high-potential side terminal of the fourth lower arm switch S4L and (ii) the fourth AC terminal Tac4.

The power conversion device 10 includes a first single-phase charge switch 55 provided to the connection path 54. When being in an on state, the first single-phase charge switch 55 enables bidirectional current flow therethrough. When being in an off state, the first single-phase charge switch 55 prevents bidirectional current flow therethrough.

The power conversion device 10 includes a second single-phase charge switch 56. The second single-phase charge switch 56 connects between (i) a portion of the first path 51 located closer to the first AC terminal Tac1 than the first inductor 61 is and (ii) a portion of the second path 52 located closer to the second AC terminal Tac2 than the second inductor 62 is.

When being in the on state, the second single-phase charge switch 56 enables bidirectional current flow therethrough. When being in the off state, the second single-phase charge switch 56 prevents bidirectional current flow therethrough.

The power conversion device 10 includes a first interrupting switch 57, a second interrupting switch 58, and a third interrupting switch 59.

On the first path 51, the first interrupting switch 57 is connected between (i) a connection point with the second single-phase charge switch 56 and (ii) the first AC terminal Tac1. On the second path 52, the second interrupting switch 58 is connected between (i) a connection point with the second single-phase charge switch 56 and (ii) the second AC terminal Tac2. The third interrupting switch 59 is connected between the third inductor 63 and the third AC terminal Tac3 on the third path 53.

When being in the on state, each of the interrupting switches 57, 58, 59 enables bidirectional current flow therethrough. When being in the off state, each of the interrupting switches 57, 58, 59 prevents bidirectional current flow therethrough.

The power conversion device 10 includes, as a configuration for reducing ripple in DC power output from the DC terminals TdcH and TdcL, a series connection of a compensating capacitor 70, which serves as a compensating power storage unit, and a compensating switch 71.

The compensating switch 71 is connected to a portion of the third path 53 located closer to the third inductor 63 than the third interrupting switch 59 is.

The compensating capacitor 70 has opposite first and second terminals. The compensating switch 71 is connected with the first terminal of the compensating capacitor 70, and the second terminal of the compensating capacitor 70 is connected with the low-potential side path LL. The compensating capacitor 70 is comprised of, for example, a film capacitor.

When being in the on state, the compensating switch 71 enables bidirectional current flow therethrough. When being in the off state, the compensating switch 71 prevents bidirectional current flow therethrough.

The power conversion device 10 includes a bypass switch 80 for connecting the compensating capacitor 70 in parallel to the DC side capacitor 50. The bypass switch 80 connects between (i) an electric path that connects the compensating switch 71 and the compensating capacitor 70 and (ii) the high-potential side path LH. When being in the on state, the bypass switch 80 enables bidirectional current flow therethrough. When being in the off state, the bypass switch 80 prevents bidirectional current flow therethrough.

The power conversion device 10 includes a DC side voltage sensor 90, an AC side voltage sensor 91, and a compensating voltage sensor 92.

The DC side voltage sensor 90 is configured to detect a terminal voltage across the DC side capacitor 50. The AC side voltage sensor 91 is configured to detect a difference between a voltage at the first AC terminal Tac1 and a voltage at the fourth AC terminal Tac4. The compensating voltage sensor 92 is configured to detect a terminal voltage across the compensating capacitor 70.

The power conversion device 10 includes first to third current sensors 93A to 93C.

The first current sensor 93A is configured to detect a current flowing through the first inductor 61. The second current sensor 93B is configured to detect a current flowing through the second inductor 62. The third current sensor 93C is configured to detect a current flowing through the third inductor 63. Measurements from the sensors 90 to 92, 93A to 93C are input to a control device 100 included in the power conversion device 10 as a control unit.

The control device 100 is mainly configured by a microcomputer 101. The microcomputer 101 includes a CPU. Functions provided by the microcomputer 101 can be provided by software stored in a tangible memory device and a computer executing the software, only software, only hardware, or a combination thereof. For example, when the microcomputer 101 is provided by an electronic circuit, which is hardware, the microcomputer 101 can be provided by a digital circuit including many logic circuits or an analog circuit. For example, the microcomputer 101 is configured to execute programs stored in a non-transitory tangible storage medium serving as a storage unit included therein. The programs include program instructions that implement routines illustrated in, for example, FIGS. 3, 6 to 9 described later.

The microcomputer 101 is configured to execute the programs to accordingly execute one or more methods corresponding to the programs. The storage unit is comprised of, for example, a non-volatile memory. It is noted that the programs stored in the storage unit can be updated through a communication network such as OTA (Over The Air) and/or the Internet.

The control device 100 is configured to perform charging control for supplying input power from the AC terminals to the storage battery 40 through the first DC-DC converter 20 and the second DC-DC converter 30. The control device 100 is additionally configured to perform discharging control for outputting power, which is supplied from the storage battery 40, from the AC terminals through the second DC-DC converter 30, the first DC-DC converter 20, and the power conversion device 10.

In each of the charging control and discharging control, the control device 100 is configured to perform switching control of each of the first DC-DC converter 20 and the second DC-DC converter 30.

The devices 20, 30, and 10 can each be controlled individually by their respective control devices. However, since individual control is not essential, FIG. 1 illustrates a single control device 100 that controls the devices 20, 30, and 10 collectively.

As illustrated in FIG. 4, the first to third AC terminals Tac1 to Tac3 can be electrically connected with the three-phase AC power supply 43 (corresponding to a plural-phase AC unit and a three-phase AC unit) via EVSE (Electric Vehicle Service Equipment) 42.

The three-phase AC power supply 43 is, for example, a system power supply. The three-phase AC power supply 43 is configured to output three-phase voltages that have a predetermined amplitude and a predetermined frequency. The three-phase output voltages of the three-phase AC power supply 43 have 120° phase shifts between each other. Similarly, the three-phase output currents of the three-phase AC power supply 43 have 120° phase shifts between each other.

Although not shown, the first to third AC terminals Tac1 to Tac3 can be electrically connected with a three-phase AC load (corresponding to a three-phase AC unit) via the EVSE 42. As illustrated in FIG. 4, the three-phase AC power supply 43 has a neutral point connected to the fourth AC terminal Tac4. The neutral point may not be connected to the fourth AC terminal Tac4.

As illustrated in FIG. 5, the first AC terminal Tac1 and the fourth AC terminal Tac4 can be electrically connected with the single-phase AC power supply 41 (corresponding to a single-phase AC unit) via the EVSE 42. The single-phase AC power supply 41 is configured to output a voltage whose amplitude is identical to the amplitude of each of the three-phase output voltages of the three-phase AC power supply 43. In addition, the frequency of the output voltage of the single-phase AC power supply 41 is the same as the frequency of each of the three-phase output voltages of the three-phase AC power supply 43. Although not shown, the first AC terminal Tac1 and the fourth AC terminal Tac4 can be electrically connected with a single-phase AC load (corresponding to a single-phase AC unit) via the EVSE 42.

The control device 100 is configured to execute a charging/discharging control routine capable of switchably performing three-phase or single-phase charging and discharging operations.

The following describes the charging/discharging control routine using the flowchart of FIG. 3.

When starting the charging/discharging control routine, the control device 100 determines whether a three-phase charging control request or a three-phase discharging control request has occurred in step S10.

For example, the control device 100 determines whether the three-phase charging control request or three-phase discharging control request has occurred based on an instruction transmitted from a processing unit (e.g., a microcomputer) included in the EVSE 42 through, for example, CAN (Controller Area Network) communications.

The three-phase charge control is configured to perform switching control of each of the power conversion device 10, the first DC-DC converter 20, and the second DC-DC converter 30 to accordingly charge the storage battery 40 based on the three-phase AC power supplied from the storage battery 40.

The three-phase discharge control is configured to perform switching control of each of the second DC-DC converter 30, the first DC-DC converter 20, and the power conversion device 10 to accordingly supply electrical power from the storage battery 40 to the three-phase AC power supply 43, which is a system power supply outside the vehicle. This discharging control will also be referred to as V2G (Vehicle to Grid) discharging control.

The three-phase discharge control is additionally configured to perform switching control of each of the second DC-DC converter 30, the first DC-DC converter 20, and the power conversion device 10 to accordingly supply the electrical power from the storage battery 40 to the three-phase AC load. When the three-phase AC load is electrical equipment in a building such as a house, this discharging control will be referred to as V2H (Vehicle to Home) discharging control.

In response to determination that no three-phase charging control request and three-phase discharging control request have occurred (NO in step S10), the charging/discharging control routine proceeds to step S11.

In step S11, the control device 100 determines whether a single-phase charging control request or a single-phase discharging control request has occurred.

For example, the control device 100 determines whether the single-phase charging control request or the single-phase discharging control request has occurred based on an instruction transmitted from the processing unit included in the EVSE 42.

The single-phase charging control is configured to perform switching control of each of the power conversion device 10, the first DC-DC converter 20, and the second DC-DC converter 30 to accordingly charge the storage battery 40 based on the single-phase AC power supplied from the single-phase AC power supply 41.

The single-phase discharging control is configured to perform switching control of each of the power conversion device 10, the first DC-DC converter 20, and the second DC-DC converter 30 to accordingly supply the electrical power supplied from the storage battery 40 to the single-phase AC load. When the single-phase AC load is electrical equipment in a building such as a house, this discharging control will be referred to as V2H control.

In response to determination that the single-phase charging control request or the single-phase discharging control request has occurred (YES in step S11), the charging/discharging control routine proceeds to step S12.

In step S12, the control device 100 controls each of the first single-phase charge switch 55, the second single-phase charge switch 56, the first interrupting switch 57, and the compensating switch 71 to be on, and controls each of the second interrupting switch 58, the third interrupting switch 59, and the bypass switch 80 to be off (see FIG. 5).

Following the operation in step S12, the control device 100 performs the single-phase charging control or the single-phase discharging control corresponding to the single-phase charging control request or the single-phase discharging control request in step S13.

The following describes the single-phase charging control first.

The single-phase charging control performs switching control of each of the first upper arm switch S1H, the first lower arm switch S1L, the second upper arm switch S2H, and the second lower arm switch S2L to accordingly convert the AC power input from the first AC terminal Tac1 and the fourth AC terminal Tac4 into DC power, thus outputting the DC power from the high-potential side DC terminal TdcH and the low-potential side DC terminal TdcL.

Specifically, the single-phase charging control alternately turns on the upper and lower arm switches in each phase in synchronization with one another with a dead time interposed between their on and off operations. In each phase, the switching period of the upper and lower arm switches is the same, and is also identical to the switching period used in the three-phase charging control.

In addition, the single-phase charging control performs switching control of each of the third upper arm switch S3H and the third lower arm switch S3L to accordingly reduce ripple in the DC power output from the high-potential side DC terminal TdcH and the low-potential side DC terminal TdcL.

Specifically, the single-phase charging control alternately turns on the third upper arm switch S3H and the third lower arm switch S3L with a dead time being interposed between their on and off operations. The switching period of the third upper and lower arm switches S3H, S3L is the same and is also identical to the switching period of each of the first and second upper and lower arm switches S1H, S1L, S2H, S2L.

The single-phase charging control controls the fourth lower arm switch S4L to be on and controls the fourth upper arm switch S4H to be off in a first time period in which current flows from the fourth AC terminal Tac4 to the first AC terminal Tac1 through the single-phase AC power supply 41. In contrast, the single-phase charging control controls the fourth upper arm switch S4H to be on and controls the fourth lower arm switch S4L to be off in a second time period in which current flows from the first AC terminal Tac1 to the fourth AC terminal Tac4 through the single-phase AC power supply 41. Whether the present timing is included in the first time period or the second time period may be determined based on, for example, a measurement from the first current sensor 93A.

The switching period of each of the fourth upper and lower arm switches S4H, S4L is set to be identical to a period of the output voltage of the single-phase AC power supply 41, and is set to be longer than the switching period of each of the first, second, and third upper and lower arm switches S1H, S1L, S2H, S2L, S3H, S3L.

This is because, for the first to third phases, high-frequency switching (e.g., several tens to several hundreds of kHz) is required in order to reduce current ripple in inductors 61 to 63, whereas for the fourth phase, switching at a frequency equivalent to the fundamental frequency of the single-phase AC power supply 41 (e.g., 50 Hz or 60 Hz) is sufficient.

Next, the following describes the single-phase discharging control.

The single-phase discharging control performs switching control of each of the first upper arm switch S1H, the first lower arm switch S1L, the second upper arm switch S2H, and the second lower arm switch S2L to accordingly convert DC power input from the high-potential side DC terminal TdcH and the low-potential side DC terminal TdcL into AC power, thus outputting the AC power from the first AC terminal Tac1 and the fourth AC terminal Tac4.

Specifically, the single-phase discharging control alternately turns on the upper and lower arm switches in each phase in synchronization with one another with a dead time interposed between their on and off operations. In each phase, the switching period of each of the upper and lower arm switches is the same and is also identical to the switching period used in the three-phase discharging control.

In addition, the single-phase discharging control controls the fourth upper arm switch S4H to be on and controls the fourth lower arm switch S4L to be off in the first time period in which current flows from the fourth AC terminal Tac4 to the first AC terminal Tac1 through the single-phase AC power supply 41. In contrast, the single-phase discharging control controls the fourth lower arm switch S4L to be on, and controls the fourth upper arm switch S4H to be off in the second time period in which current flows from the first AC terminal Tac1 to the fourth AC terminal Tac4 through the single-phase AC power supply 41.

Otherwise, in response to determination that the three-phase charging control request or the three-phase discharging control request has occurred (YES in step S10), the charging/discharging control routine proceeds to step S14.

In step S14, the control device 100 controls each of the first interrupting switch 57, the second interrupting switch 58, the third interrupting switch 59, and the bypass switch 80 to be on, and controls each of the first single-phase charge switch 55, the second single-phase charge switch 56, and the compensating switch 71 to be off (see FIG. 4). The control device 100 also controls each of the fourth upper arm switch S4H and the fourth lower arm switch S4L to be off.

Following the operation in step S14, the control device 100 performs the three-phase charging control or the three-phase discharging control corresponding to the three-phase charging control request or the three-phase discharging control request in step S15.

The following describes the three-phase charging control first.

The three-phase charging control performs switching control of each of the first, second, and third upper arm switches S1H, S2H, S3H and the first, second, and third lower arm switches S1L, S2L, S3L to accordingly convert the three-phase AC power input from the first AC terminal Tac1, the second AC terminal Tac2, and the third AC terminal Tac3 into DC power, thus outputting the DC power from the high-potential side DC terminal TdcH and the low-potential side DC terminal TdcL.

Specifically, the three-phase charging control alternately turns on the upper and lower arm switches in each phase with a dead time interposed between their on and off operations. In each phase, the switching period of the upper and lower arm switches is the same.

Next, the following describes the three-phase discharging control.

The three-phase discharging control performs switching control of the first, second, and third upper arm switches S1H, S2H, S3H and the first, second, and third lower arm switches S1L, S2L, S3L to accordingly convert DC power input from the high-potential side DC terminal TdcH and the low-potential side DC terminal TdcL into three-phase AC power, thus outputting the three-phase AC power from the first AC terminal Tac1, the second AC terminal Tac2, and the third AC terminal Tac3.

Specifically, the three-phase discharging control alternately turns on the upper and lower arm switches in each phase with a dead time interposed between their on and off operations. In each phase, the switching period of the upper and lower arm switches is the same.

Next, the following describes the three-phase charging control and the three-phase discharging control in detail.

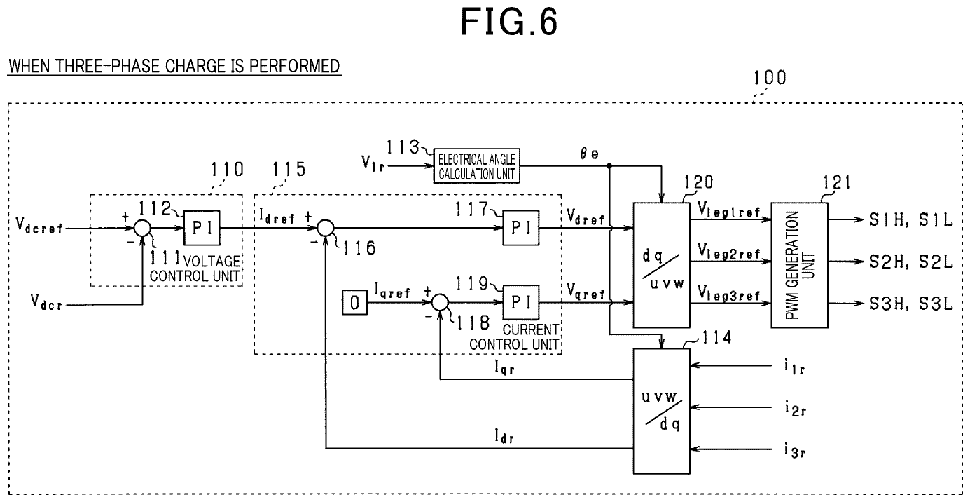

First, the following describes the three-phase charging control with reference to FIG. 6.

FIG. 6 is a block diagram of the control device 100 as configured to perform a three-phase charging control process.

The control device 100, when configured to perform the three-phase charging control process, includes a voltage control unit 110, an electrical angle calculation unit 113, a two-phase conversion unit 114, a current control unit 115, a three-phase conversion unit 120, and a PWM (Pulse Width Modulation) generation unit 121.

The voltage control unit 110 is configured to calculate a d-axis target current Idref for controlling a terminal voltage across the DC side capacitor 50 (hereinafter, a DC voltage detection value Vdcr) detected by the DC side voltage sensor 90 to a target DC voltage Vdcref.

Specifically, the voltage control unit 110 includes a voltage deviation calculation unit 111 and a voltage feedback control unit 112.

The voltage deviation calculation unit 111 is configured to subtract the DC voltage detection value Vdcr from the target DC voltage Vdcref to calculate a voltage deviation ΔV. The target DC voltage Vdcref may be set based on, for example, rated voltages of the upper and lower arm switches S1H to S4L and the first DC-DC converter 20.

The voltage feedback control unit 112 is configured to calculate the d-axis target current Idref as a manipulated variable for feedback control, i.e., proportional-integral control, of the voltage deviation ΔV to 0.

The electrical angle calculation unit 113 is configured to calculate an electrical angle θe based on a voltage detected by the AC side voltage sensor 91 (hereinafter, AC voltage detection value V1r). The electrical angle θe according to the present embodiment is set to 0°,

In the present embodiment, the electrical angle θe is defined as 0° at the zero-crossing timing of the AC voltage detection value V1r—specifically, for example, at the upward zero-crossing timing—and defined as 360° at the next upward zero-crossing timing. This enables one period of the AC voltage detection value Vir to correspond to one cycle of the electrical angle (0° to 360°). In the present embodiment, the AC voltage detection value V1r is defined as positive when the voltage at the first AC terminal Tac1 is higher than the voltage at the fourth AC terminal Tac4.

The two-phase conversion unit 114 is configured to convert first, second, and third current detection values i1r, i2r, i3r detected by respective first, second, and third current sensors 93A, 93B, 93C in a three-phase fixed coordinate system into d- and q-axis currents Idr and Iqr in a two-phase rotating coordinate system (dq axis coordinate system) based on the electrical angle θe. In the present embodiment, the first, second, and third current detection values i1r, i2r, i3r are defined as positive values when the corresponding currents i1r, i2r, i3r flow from the side of the first, second, and third AC terminals Tac1, Tac2, Tac3 to the side of the first, second, and third inductors 61, 62, 63.

The current control unit 115 includes a d-axis deviation calculation unit 116, a d-axis feedback control unit 117, a q-axis deviation calculation unit 118, and a q-axis feedback control unit 119.

The d-axis deviation calculation unit 116 is configured to subtract the d-axis current Idr from the d-axis target current Idref to calculate a d-axis current deviation ΔId. The d-axis feedback control unit 117 is configured to calculate a d-axis target voltage Vdref as a manipulated variable for feedback control, i.e., proportional-integral control, of the d-axis current deviation ΔId to 0.

The q-axis deviation calculation unit 118 is configured to subtract the q-axis current Iqr from a q-axis target current Iqref to calculate a q-axis current deviation ΔIq. The q-axis target current Iqref is a target value of reactive current and has been set to 0 in order to set a power factor to 1 in the present embodiment.

Setting the power factor to 1 represents setting a phase difference between each of first, second, and third output voltage V1, V2, V3 of the three-phase AC power supply 43 and the corresponding one of the first, second, and third current detection values i1r, i2r, i3r to 0.

The q-axis feedback control unit 119 is configured to calculate a q-axis target voltage Vqref as a manipulated variable for feedback control, i.e., proportional-integral control, of the q-axis current deviation ΔIq to 0.

The three-phase conversion unit 120 is configured to convert each of the d- and q-axis target voltages Vdref and Vqref in the two-phase rotating coordinate system into first, second, and third target voltages Vleg1ref, Vleg2ref, Vleg3ref in the three-phase fixed coordinate system based on the electrical angle θe. The first, second, and third target voltages Vleg1ref, Vleg2ref, Vleg3ref are each a substantially sinusoidal signal and have 120° phase shifts between each other.

The three-phase conversion unit 120 may be configured to calculate the first, second, and third target voltages Vleg1ref, Vleg2ref, Vleg3ref so that first DC power P1, second DC power P2, and third DC power P3 are equal to one another. The first DC power P1, the second DC power P2, and the third DC power P3 are individually transferred between the AC terminals Tac1 to Tac3 and the DC terminals TdcH and TdcL through the first, second, and third inductors 61, 62, and 63. This results in effective values of currents flowing through the respective first, second, and third inductors 61, 62, and 63 being equivalent to each other (e.g., 16 Arms).

The PWM generation unit 121 is configured to perform pulse-width modulation (PWM) through magnitude comparison between the first, second, and third target voltages (Vleg1ref, Vleg2ref, and Vleg3ref) and a carrier signal to accordingly generate first gate drive signals for driving the gates of the upper and lower arm switches S1H and S1L, second gate drive signals for drivint the gates of the upper and lower arm switches S2H and S2L, and third gate drive signals 20) for driving the gates of the upper and lower arm switches S3H and S3L.

The carrier signal is, for example, a triangular wave signal. One period of the carrier signal is sufficiently shorter than one cycle of the electrical angle (0° to 360°). Within one cycle of the electrical angle, the switching patterns of the first (S1H/S1L), second (S2H/S2L), and third (S3H/S3L) upper and lower arm switches are phase-shifted by 120° from each other.

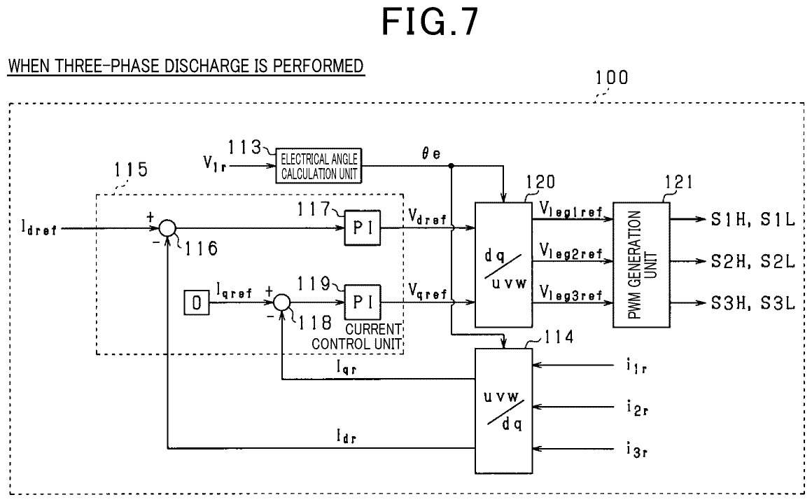

Next, the following describes the three-phase discharging control with reference to FIG. 7.

FIG. 7 is a block diagram of the control device 100 as configured to perform a three-phase discharging control process.

The control device 100 is configured to perform switching control of the first DC-DC converter 20 to thereby perform the three-phase discharging control process for controlling the DC voltage detection value Vdcr to the target DC voltage Vdcref. For this reason, the block diagram of the control device 100 configured to perform the three-phase discharging control process shown in FIG. 7 is substantially identical to that of the control device 100 configured to perform the three-phase charging control process shown in FIG. 6, except that the voltage control unit 110 illustrated in FIG. 6 is omitted in FIG. 7.

The d-axis target current Idref (e.g., −16 A) input to the d-axis deviation calculation unit 116 in the three-phase discharging control process is set to a value having a sign different from that of the d-axis target current Idref (e.g., +16 A) used when the three-phase charging control process is performed.

Next, the following describes the single-phase charging control and the single-phase discharging control in detail.

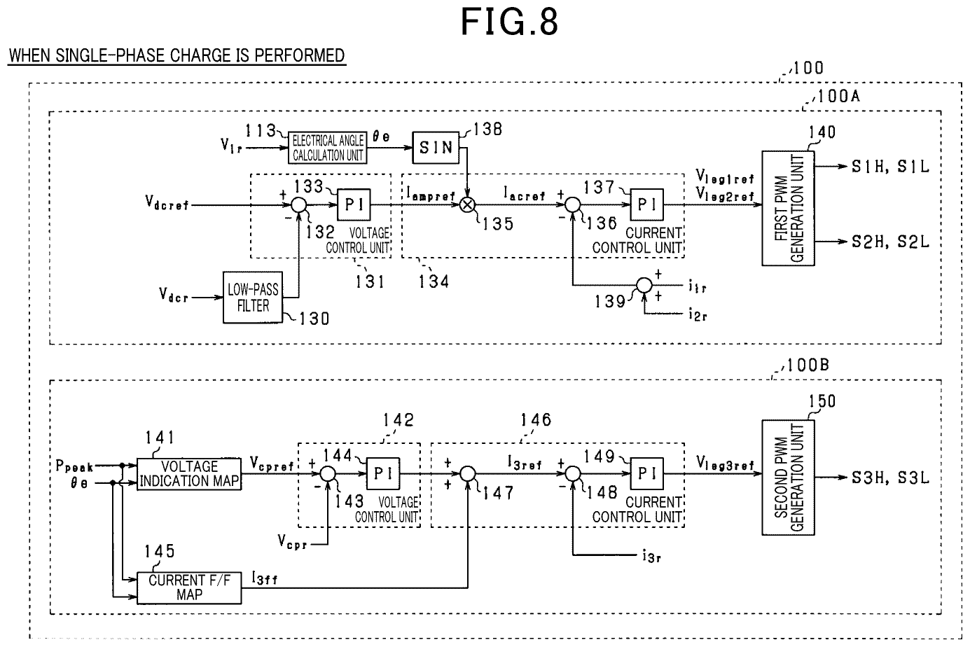

First, the following describes the single-phase charging control with reference to FIG. 8.

FIG. 8 is a block diagram of the control device 100 as configured to perform a single-phase charging control process.

The control device 100, when configured to perform the single-phase charging control process, includes a charging control unit 100A for power transfer and a ripple reduction control unit 100B for ripple reduction in DC power.

The charging control unit 100A includes a filter unit 130, a voltage control unit 131, a current control unit 134, and a first PWM generation unit 140.

The filter unit 130 is configured to subject the DC voltage detection value Vdcr to lowpass filter processing. This results in harmonic components of the output voltage of the single-phase AC power supply 41 included in the DC voltage detection value Vdcr being removed. The harmonic components are, for example, components of a secondary frequency of the output voltage (e.g., 100 Hz or 120 Hz).

The voltage control unit 131 includes a voltage deviation calculation unit 132 and a voltage feedback control unit 133.

The voltage deviation calculation unit 132 is configured to subtract the DC voltage detection value Vdcr from the target DC voltage Vdcref, from which the harmonic components have been removed by the filter unit 130, to calculate the voltage deviation ΔV.

The voltage feedback control unit 133 is configured to calculate a target current amplitude Iampref as a manipulated variable for feedback control of the voltage deviation ΔV to 0.

The electrical angle calculation unit 113 is configured to calculate the electrical angle θₑ based on the AC voltage detection value V1r.

The sinusoidal wave generation unit 138 is configured to generate a sine signal represented as sin θₑ using the calculated electrical angle θₑ.

The current control unit 134 includes a target current calculation unit 135, a current deviation calculation unit 136, and a current feedback control unit 137.

The target current calculation unit 135 is configured to multiple the target current amplitude Iampref by the sinusoidal signal sinde to calculate a target current Iacref. The target current Iacref varies at the same period as that of the AC voltage detection value V1r. 25

The current deviation calculation unit 136 is configured to subtract the sum of the first current detection value i1r and the second current detection value 21r from the target current Iacref to calculate a current deviation ΔV. The sum of the first current detection value i1r and the second current detection value i2r is calculated by a current addition unit 139.

The current feedback control unit 137 is configured to calculate the first and second target voltages Vleg1ref and Vleg2ref as manipulated variables for feedback control, i.e., proportional-integral control, of the current deviation ΔI to 0. In the present embodiment, the first and second target voltages Vleg1ref and Vleg2ref have the same phase. In particular, the current feedback control unit 137 of the present embodiment is configured to calculate the first and second target voltages Vleg1ref and Vleg2ref so that the first DC power P1 and the second DC power P2 are equal to each other.

The first PWM generation unit 140 is configured to perform pulse-width modulation (PWM) through magnitude comparison between the first and second target voltages (Vleg1ref and Vleg2ref) and the carrier signal to accordingly generate (i) first upper and lower arm drive signals for driving the gates of the upper and lower arm switches S1H and S1L and (ii) second upper and lower arm drive signals for driving the gates of the upper and lower arm switches S2H and S2L.

Within one cycle of the electrical angle, the phase difference between the switching pattern of the first (S1H/S1L) and the switching patter of the second and second (S2H/S2L) is zero. That is, on-switching timings and off-switching timings of the first upper arm switch S1H and the second upper arm switch S2H are synchronized with each other, and on-switching timings and off-switching timings of the first lower arm switch S1L and the second lower arm switch S2L are synchronized with each other.

Next, the following describes the ripple reduction control unit 100B.

The ripple reduction control unit 100B includes a target compensating voltage calculation unit 141, a voltage control unit 142, a feedforward current calculation unit 145, a current control unit 146, and a second PWM generation unit 150.

The target compensating voltage calculation unit 141 is configured to calculate a target compensating voltage Vcpref, which is a target value of a terminal voltage across the compensating capacitor 70 for reducing ripple in DC power Pdc. Specifically, the target compensating voltage calculation unit 141 is configured to calculate the target compensating voltage Vcpref based on a ripple compensating amplitude Ppeak, the electrical angle θe, and the following expression (eq1):

$$V cpref = \sqrt{\frac{Ppeak}{Ccpr \cdot ω} ( K - sin 2 ω t )} \qquad ( eq 1 )$$

The ripple compensating amplitude Ppeak [W] represents a value determined based on the amplitude of an output voltage Vac of the single-phase AC power supply 41. Specifically, the ripple compensating amplitude Ppeak represents a value equivalent (e.g., equal) to the amplitude of the output voltage Vac. In the above expression (eq1), ω indicates an angular frequency [rad./sec] of the output voltage Vac, and t indicates elapsed time [sec.] from the upward zero-crossing timing at which the output voltage Vac changes from a negative to a positive. The elapsed time t can be determined based on the electrical angle θe. In addition, a relationship of θe=ω*t is established.

In the above expression (eq1), reference character Ccpr represents capacitance [F] of the compensating capacitor 70. K is a real number more than or equal to 1, and is for example set to 1.

The target compensating voltage calculation unit 141 may be configured to refer to map information in which various of the ripple compensating amplitude Ppeak and corresponding values of the electrical angle θe are associated with each other to accordingly calculate a value of the target compensating voltage Vcpref corresponding to a value of the electrical angle θe.

The voltage control unit 142 includes a compensating voltage deviation calculation unit 143 and a compensating voltage feedback control unit 144.

The compensating voltage deviation calculation unit 143 is configured to subtract the voltage detected by the compensating voltage sensor 92 (hereinafter, compensating voltage detection value Vcpr) from the target compensating voltage Vcpref to calculate a compensating voltage deviation ΔVp. The compensating voltage feedback control unit 144 is configured to calculate a target feedback current I3fb as a manipulated variable for feedback control, i.e . . . , proportional-integral control, of the compensating voltage deviation ΔVp to 0.

The feedforward current calculation unit 145 is configured to calculate a target feedforward current I3ff based on the ripple compensating amplitude Ppeak, the electrical angle θe, and the following expression (eq2):

$$I 3 ff = \frac{- P p eak \cdot cos 2 ω t}{\sqrt{\frac{P p e a k}{Ccpr \cdot ω} ( K - sin 2 ω t )}} \qquad ( eq 2 )$$

The feedforward current calculation unit 145 may be configured to refer to map information in which values of the ripple compensating amplitude Ppeak and corresponding values of the electrical angle θe are associated with each other to accordingly calculate a value of the ripple compensating amplitude Ppeak corresponding to a value of the electrical angle θe.

The current control unit 146 includes an addition section 147, a compensating current deviation calculation unit 148, and a compensating current feedback control unit 149.

The addition section 147 is configured to add the target feedforward current I3ff to the target feedback current I3fb to calculate a target compensating current I3ref. Because the feedforward current calculation unit 145 is not an essential component for the ripple reduction control unit 100B. In this modification, the target feedback current I3fb can be used as the target compensating current I3ref.

The compensating current deviation calculation unit 148 is configured to subtract the third current detection value i3r from the target compensating current I3ref to calculate a compensating current deviation ΔIp.

The compensating current feedback control unit 149 is configured to calculate a third target voltage Vleg3ref as a manipulated variable for feedback control, i.e., proportional-integral control, of the compensating current deviation ΔIp to 0. T

The second PWM generation unit 150 is configured to perform pulse-width modulation (PWM) through magnitude comparison between the third target voltage Vleg3ref and the carrier signal to accordingly generate the third upper and lower arm drive signals for driving the gates of the third upper and lower arm switches S3H and S3L.

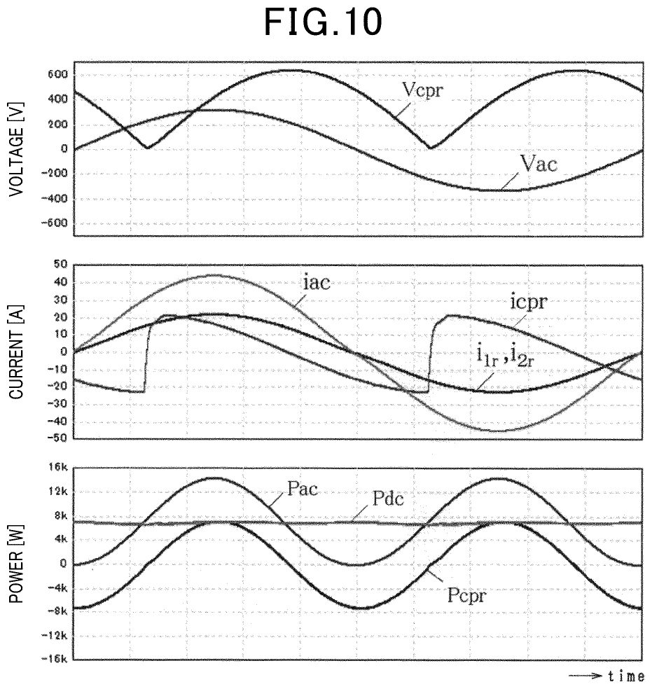

FIG. 10 illustrates, during the single-phase charging control, (i) a transition of the compensating voltage detection value Vcpr, (ii) 20 transitions of the output voltage Vac and output current iac of the single-phase AC power supply 41, (iii) a transition of the current icpr flowing through the compensating capacitor 70, (iv) transitions of the first and second current detection values i1r and i2r, (v) a transition of the output power Pac of the single-phase AC power supply 41, (vi) a transition of the power Pcpr (=Vcpr*icpr) of the compensating capacitor 70, and (vii) a transition of the DC power Pdc output from the DC terminals TdcH and TdcL.

The compensating voltage detection value Vcpr is defined as positive when the voltage at the second terminal of the compensating capacitor 70 connected to the low-potential side path LL is higher than the voltage at the first terminal of the compensating capacitor 70 connected to the third path 53 through the compensating switch 71.

The output voltage Vac of the single-phase AC power supply 41 is defined as positive when the voltage at the first AC terminal Tac1 is higher than the voltage at the fourth AC terminal Tac4.

The output current iac of the single-phase AC power supply 41 is defined as positive when the current flows from the side of the fourth AC terminal Tac4 to the side of the first AC terminal Tac1.

The current icpr flowing through the compensating capacitor 70 is defined as positive when the current flows from the first terminal of the compensating capacitor 70 connected to the third path 53 through the compensating switch 71 to the second terminal of the compensating capacitor 70 connected to the low-potential side path LL.

In the example illustrated in FIG. 10, the frequency of the output voltage Vac of the single-phase AC power supply 41 is 50 Hz, the effective value of the output voltage Vac is 230 Vrms, and the target DC voltage Vdcref is set to 800 V. In addition, the DC power Pdc is defined as a value of ⅔ of the DC power Pdc used for execution of the three-phase charging control.

(I) High-frequency switching control of each of the first and second upper and lower arm switches S1H, S1L, S2H, S2L and (II) switching control of each of the fourth upper and lower arm switches S4H and S4L at 50 Hz, which are included in the single-phase charging control, enable, as illustrated in FIG. 10, the phase difference between 25 the output voltage Vac of the single-phase AC power supply 41 and the first current detection value i1r and the phase difference between the output voltage Vac of the single-phase AC power supply 41 and the second current detection value i2r to be zero (i.e., the power factor is 1).

The current feedback control unit 137 of the present embodiment is configured to calculate, during the single-phase charge control, the first and second target voltages Vleg1ref and Vleg2ref so that the first DC power P1 and the second DC power P2 are equal to each other. This results in, as shown in the example illustrated in FIG. 10, the effective values of the currents flowing through the respective first and second inductors 61, 62 being 16 Arms.

In the example illustrated in FIG. 10, the output power Pac of the single-phase AC power supply 41 (i.e., input power of the power conversion device 10) ripples at a frequency twice the fundamental frequency of the output voltage Vac of the single-phase AC power supply 41, and ripples with the amplitude of 7360 W centering on 7360 W.

The third upper and lower arm switches S3H, S3L are subjected to switching control so that the compensating voltage detection value Vcpr is controlled to the target compensating voltage Vcpref for reducing the ripple components. Hence, the ripple components of the input power are absorbed into the compensating capacitor 70 as reactive power, and the DC power Pdc transferred to the DC terminals TdcH, TdcL becomes constant at approximately 7360 W. This makes it possible to use the DC side capacitor 50 whose capacitance is lower, resulting in the DC side capacitor 50 having a smaller size.

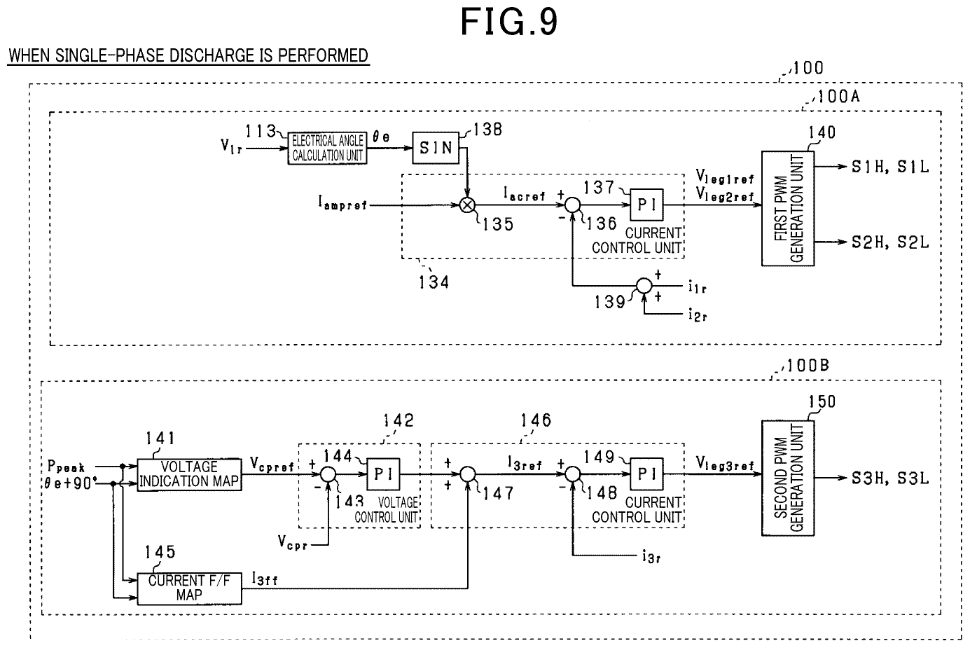

Next, the following describes the single-phase discharging control with reference to FIG. 9.

Like the three-phase discharging control, the control device 100 is configured to perform switching control of the first DC-DC converter 20 to thereby perform the single-phase discharging control process for controlling the DC voltage detection value Vdcr to the target DC voltage Vdcref. For this reason, the block diagram of the control device 100 configured to perform the single-phase discharging control process shown in FIG. 9 is substantially identical to that of the control device 100 configured to perform the single-phase charging control process shown in FIG. 8, except that the voltage control unit 130 illustrated in FIG. 8 is omitted in the ripple reduction control unit 100B illustrated in FIG. 9.

The electrical angle θ itself is used as the parameter related to the electrical angle input to the target compensating voltage calculation unit 141 in the ripple reduction control unit 100B for the single-phase charging control illustrated in FIG. 8. However, the sum of the electrical angle θ and 90°, which is expressed as (θ+90°), is used as the parameter related to the electrical angle input to the target compensating voltage calculation unit 141 in the ripple reduction control unit 100B for the single-phase discharging control illustrated in FIG. 9. This aims to invert the polarity of the power Pcpr (=Vcpr*icpr, refer to FIG. 10) of the compensating capacitor 70.

In particular, as described above, the control device 100 of the present embodiment is configured to control the bypass switch 80 to be on when executing the three-phase charging control or the three-phase discharging control.

The following describes the reason why the power conversion device 10 includes the bypass switch 80.

During execution of the three-phase discharging control, an imbalance may occur in power transferred over of multiple paths defined between the AC terminals Tac1 to Tac3 and the DC terminals TdcH and TdcL through the first to third inductors 61 to 63. If power transferred through the multiple paths becomes unbalanced, the terminal voltage Vdcr across the DC side capacitor 50 greatly varies. This may therefore lead to the need for an increase in the capacitance of the DC side capacitor 50. This may result in the size of the DC side capacitor 50 increasing.

Specifically, during execution of the three-phase discharging control, the above imbalance is likely to increase. During the three-phase charging control, it is possible to perform imbalance suppressing control that suppresses the imbalance. In contrast, during execution of the three-phase discharging control, there may be one or more circumstances that the prevents the control device 100 from performing such imbalance suppressing control.

Specifically, during execution of the three-phase charging control, the control device 100 can be configured to temporarily stop the three-phase charging control process illustrated in FIG. 6 to temporarily interrupt charging the storage battery 40, and thereafter restart the three-phase charging control process illustrated in FIG. 6 to accordingly suppress the imbalance.

That is, temporary interruption of charging of the storage battery 40 during execution of the three-phase charging control has little effect on user convenience.

In contrast, temporary interruption of power supply to the three-phase AC power supply 43 and the three-phase AC load during execution of the three-phase discharging control may cause a problem.

Specifically, in V2G, temporary interruption of power supply to the three-phase AC power supply 43 may result in the frequency of the system power supply temporarily lowering. When many vehicles are connected to the system power supply, the frequency of the system power supply may significantly lower. In addition, in V2H, temporary interruption of power supply to the three-phase AC load may cause electrical equipment to be stopped, resulting in user convenience significantly lowering.

For the above reasons, it is necessary to suppress the imbalance while continuing three-phase charge/discharging control.

From this viewpoint, the control device 100 of the present embodiment is configured to control the bypass switch 80 to be on during execution of the three-phase charging control or the three-phase discharging control. This enables (i) the compensating capacitor 70 used for the single-phase charging control or the single-phase discharging control to be connected in parallel to the DC side capacitor 50 and (ii) both of the compensating capacitor 70 and the DC side capacitor 50 to serve as smoothing capacitors. This therefore makes it possible to suppress an increase in the capacitance of the DC side capacitor 50, thus preventing an increase in the size of the DC side capacitor 50.

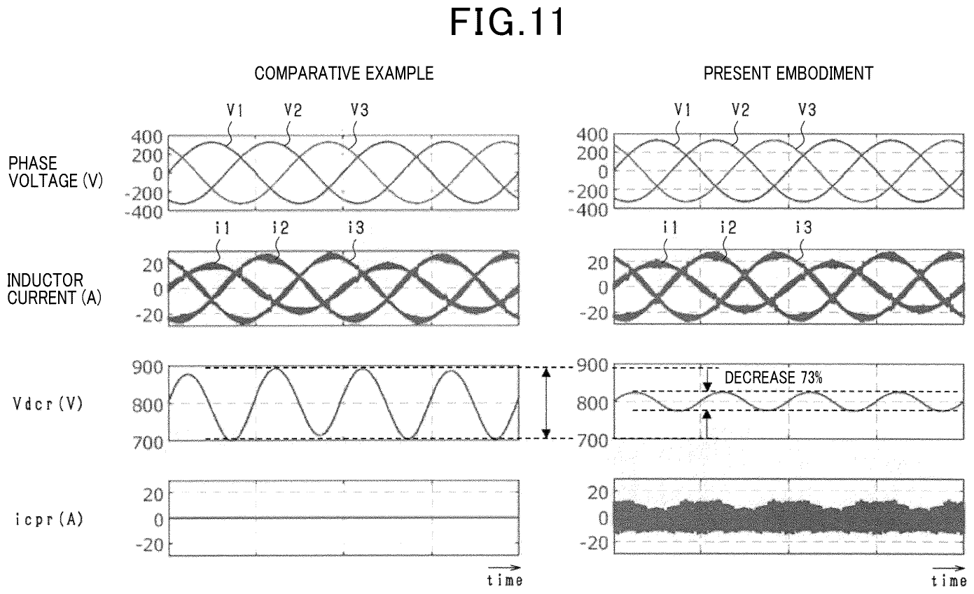

FIG. 11 illustrates a first timing chart including (i) a transition of each of the first, second, and third output voltage V1, V2, and V3 of the three-phase AC power supply 43, (ii) a transition of each of the currents i1, i2, and i3 flowing through the respective first, second, and third inductors 61, 62, and 63, (iii) a transition of the terminal voltage Vdcr across the DC side capacitor 50, and (iv) a transition of the current icpr flowing through the compensating capacitor 70, which are measured according to the present embodiment. FIG. 11 additionally illustrates a second timing chart including (i) a transition of each of the first, second, and third output voltage V1, V2, and V3 of the three-phase AC power supply 43, (ii) a transition of each of the currents i1, i2, and i3 flowing through the respective first, second, and third inductors 61, 62, and 63, (iii) a transition of the terminal voltage Vdcr across the DC side capacitor 50, and (iv) a transition of the current icpr flowing through the compensating capacitor 70, which are measured according to a comparative example, i.e., the configuration of the power conversion device disclosed in U.S. Pat. No. 8,503,208.

In particular, each of the first timing chart and the second timing chart illustrated in FIG. 11 shows a measurement result where imbalance of −20% is applied to power transferred through the first inductor 61 with respect to power transferred through each of the second and third inductors 62 and 63.

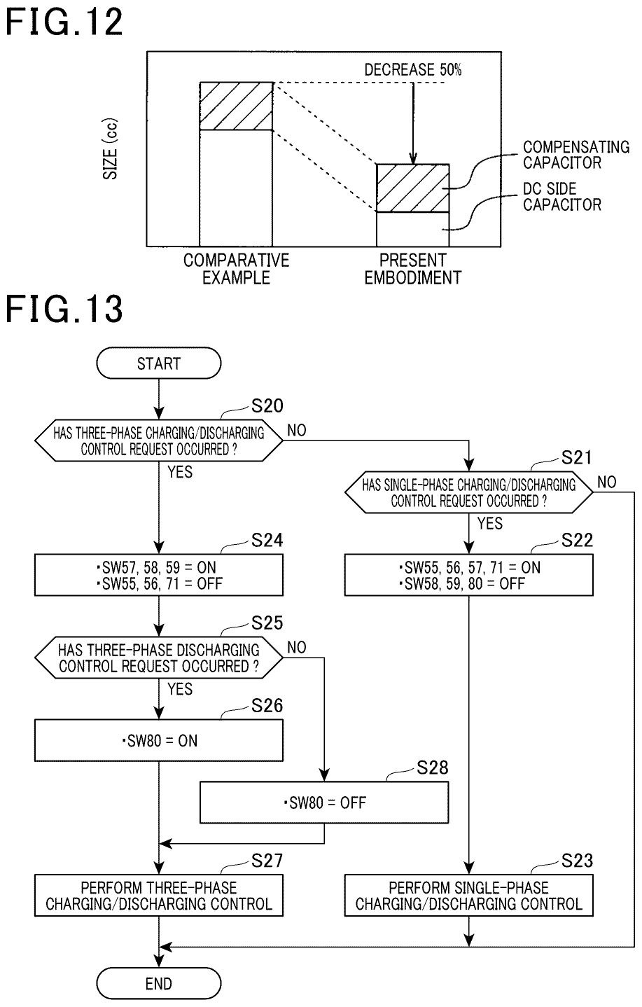

The present embodiment makes it possible to reduce the variation in the terminal voltage across Vdcr by 73% compared to the comparative example This therefore enables the capacitance of the DC side capacitor 50 to lower, resulting in the DC side capacitor 50 having a significantly smaller size (see FIG. 12).

Typically, the relationship between power P which a capacitor can absorb and capacitance C of the capacitor can be expressed by the following expression (eq3):

$$C = \frac{P}{ϖ ac \cdot V dc \cdot ΔVdc} \qquad ( eq 3 )$$

where:
ω̅ac represents an input frequency of applied voltage across the capacitor,
Vdc represents a DC component of the applied voltage across the capacitor, and
ΔVdc represents a variation range of an AC component of the applied voltage across the capacitor.

In order to stabilize the voltage of the first DC-DC converter 20 at the subsequent stage of the DC side capacitor 50, it is difficult to increase the variation range ΔVdc of the AC component of the applied voltage across the DC side capacitor 50.

In contrast, since the compensating capacitor 70 is not adjacent to a voltage converter, such as the first DC-DC converter 20, it is possible to increase the variation range ΔVdc of the AC component of the applied voltage across the compensating capacitor 70.

For this reason, in order to absorb ripple in power during the single-phase discharging control, it is more effective to increase the variation range ΔVdc of the AC component of the applied voltage across the compensating capacitor 70 than the variation range ΔVdc of the AC component of the applied voltage across the DC side capacitor 50, that is, it is more effective to increase the capacitance across the compensating capacitor 70 than that of the DC side capacitor 50.

From this viewpoint, the power conversion device 10 according to the present embodiment is configured such that the capacitance of the DC side capacitor 50 is set to be lower than that of the compensating capacitor 70, making it possible to reduce the sum of the capacitance of the DC side capacitor 50 and that of the compensating capacitor 70. This therefore enables a smaller total size of the DC side capacitor 50 and the compensating capacitor 70.

### Modifications of First Embodiment

The control device 100 according to a first modification of the first embodiment may be configured to maintain the second single-phase charge switch 56 in the off state during execution of the single-phase charging control or the single-phase discharging control. The control device 100 of this first modification may be configured to maintain each of the second upper and lower arm switches S2H and S2L in the off state.

The second single-phase charge switch 56 according to a second modification of the first embodiment may be omitted in the configuration of the power conversion device 10 illustrated in FIG. 1. The control device 100 of this second modification may be configured to maintain each of the second upper and lower arm switches S2H and S2L in the off state.

### Second Embodiment

The following describes a second embodiment with reference to FIG. 13 while focusing on the differences of the second embodiment from the first embodiment.

The control device 100 of the second embodiment is configured to turn on or maintain in the on state the bypass switch 80 in response to determination that the three-phase discharging control request has occurred, thus connecting the DC side capacitor 50 in parallel to the compensating capacitor 70.

FIG. 13 is a flowchart illustrating the charging/discharging control routine to be carried out by the control device 100 according to the second embodiment. In FIG. 13, operations in steps S20 to S23 are identical to those in steps S10 to S13 in FIG. 3, and the operation in step S27 is identical to that in step S15 in FIG. 3.

After the operation in step S24 is completed, the charging/discharging control routine proceeds to step S25.

In step S25, the control device 100 determines whether the three-phase discharging control request has occurred.

In response to determination that the three-phase discharging control request has occurred (YES in step S25), the charging/discharging control routine proceeds to step S26.

In step S26, the control device 100 controls the bypass switch 80 to be on

Otherwise, in response to determination that the three-phase charging control request has occurred (NO in step S25), the charging/discharging control routine proceeds to step S28.

In step S28, the control device 100 controls the bypass switch 80 to be off.

During execution of the three-phase charging control in which power imbalance to be unlikely to occur so that it is unnecessary to increase the capacitance of the smoothing capacitor, the control device 100 of the second embodiment prevents current from flowing through the bypass switch 80. This prevents the occurrence of loss in a resistance component of the bypass switch 80, such as a relay thereof, thus reducing loss resulting from the power conversion device 10 of the second embodiment.

### Third Embodiment

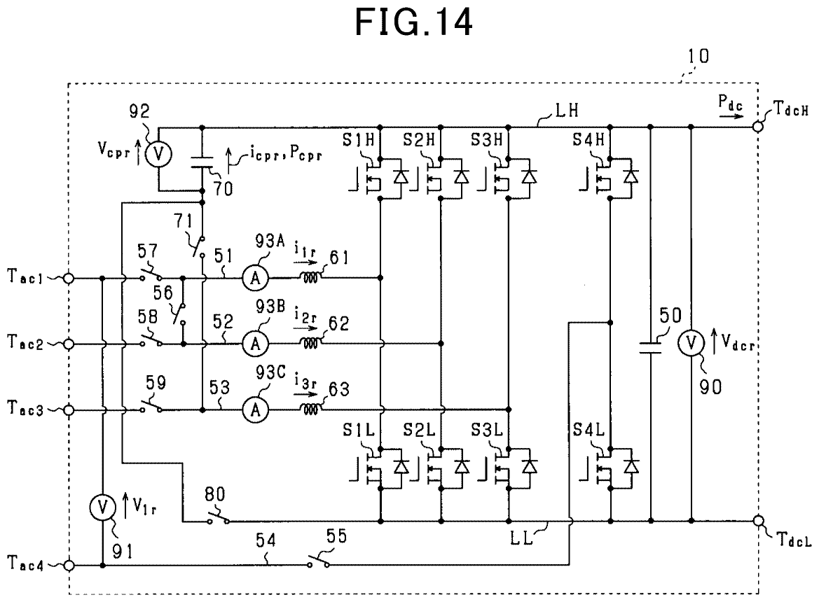

The following describes a third embodiment with reference to FIG. 14 while focusing on the differences of the third embodiment from the first and second embodiments.

The power conversion device 10 of the third embodiment is configured such that the second end of the compensating capacitor 70 is, as illustrated in FIG. 14, connected not to the low-side path LL but to the high-potential side path LH.

The third embodiment achieves advantageous effects identical to those achieved by the first embodiment or the second embodiment.

### Fourth Embodiment

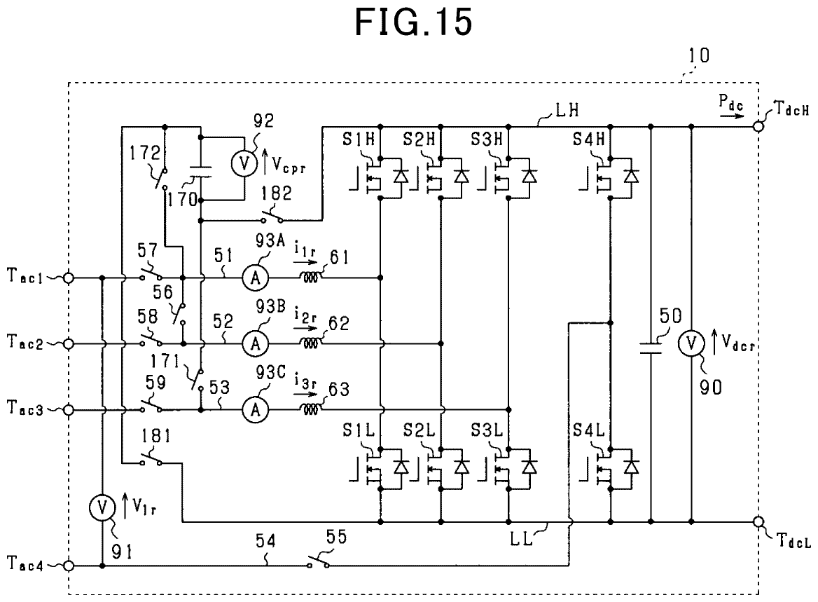

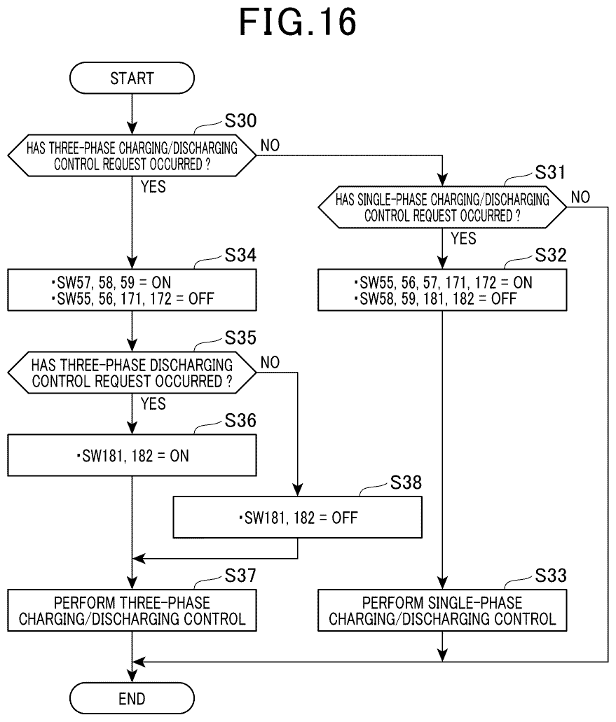

The following describes a fourth embodiment with reference to FIGS. 15 and 16 while focusing on the differences of the fourth embodiment from the second embodiment.

The circuit configuration of the power conversion device 10 of the fourth embodiment, which selects whether a compensating capacitor 170 is connected in parallel to the DC side capacitor 50, is modified.

The power conversion device 10 of the fourth embodiment includes a first bypass switch 181 and a second bypass switch 182.

The first bypass switch 181 is configured to connect the low-potential side path LL and the first terminal of the compensating capacitor 170. The second bypass switch 182 is configured to connect the second terminal of the compensating capacitor 170 and the high-potential side path LH. Controlling each of the first and second bypass switches 181 and 182 to be on causes the compensating capacitor 170 to be connected in parallel to the DC side capacitor 50. When being in the on state, each of the first and second bypass switches 181 and 182 enables bidirectional current flow therethrough. When being in the off state, each of the first and second bypass switches 181 and 182 prevents bidirectional current flow therethrough.

The power conversion device 10 of the fourth embodiment includes a first compensating switch 171 and a second compensating switch 172.

The first compensating switch 171 is configured to connect between (i) the second terminal of the compensating capacitor 170 and (ii) a portion of the third path 53 between the second interrupting switch 58 and the third inductor 63. The second compensating switch 172 is configured to connect between (i) the first terminal of the compensating capacitor 170 and (ii) a portion of the first path 51 located closer to the first AC terminal Tac1 than the first inductor 61 is.

When being in the on state, each of the first and second compensating switches 171 and 172 enables bidirectional current flow therethrough. When being in the off state, each of the first and second compensating switches 171 and 172 prevents bidirectional current flow therethrough.

FIG. 16 is a flowchart illustrating the charging/discharging control routine to be carried out by the control device 100 according to the fourth embodiment. In FIG. 16, operations in steps S30 and S31 are identical to those in steps S10 and S11 in FIG. 3, and the operation in step S37 is identical to that in step S15 in FIG. 3.

In response to determination that the single-phase charging control request or the single-phase discharging control request has occurred (YES in step S31), charging/discharging control routine proceeds to step S32.

In step S32, the control device 100 controls each of the first single-phase charge switch 55, the second single-phase charge switch 56, and the first interrupting switch 57 to be on, and controls, in order to perform ripple reduction control, each of the first and second compensating switches 171 and 172 to be on.

Additionally, the control device 100 controls each of the second interrupting switch 58 and the third interrupting switch 59 to be off in step S32. In step S32, the control device 100 controls, in order to release the parallel connection of the compensating capacitor 170 to the DC side capacitor 50, each of the first bypass switch 181 and the second bypass switch 182 to be off.

As in step S13 in FIG. 3, the control device 100 performs the single-phase charging control or the single-phase discharging control corresponding to the single-phase charging control request or the single-phase discharging control request in step S33. Additionally, like the operation in step S13, the control device 100 performs switching control of each of the fourth upper and lower arm switches S4H and S4L in step S33.

Additionally, in order to reduce ripple in the DC power output from the high-potential side terminal TdcH and the low-potential side DC terminal TdcL, the single-phase charging control alternately turns on the third upper arm switch S3H and the third lower arm switch S3L with a dead time being interposed between their on and off operations. The switching period of the third upper and lower arm switches S3H, S3L is the same and is also identical to the switching period of each of the first and second upper and lower arm switches S1H, S1L, S2H, S2L.

In response to determination that the three-phase charging control request or the three-phase discharging control request has occurred (YES in step S30), the charging/discharging control routine proceeds to step S34.

In step S34, the control device 100 controls each of the first interrupting switch 57, the second interrupting switch 58, and the third interrupting switch 59 to be on, and controls each of the first single-phase charge switch 55, the second single-phase charge switch 56, the first compensating switch 171, and the second compensating switch 172 to be off.

Following the operation in step S34, the control device 100 determines whether the three-phase discharging control request has occurred in step S35.

In response to determination that the three-phase discharging control request has occurred (YES in step S35), the charging/discharging control routine proceeds to step S36.

In step S36, the control device 100 controls each of the first and second bypass switches 181 and 182 to be on.

Otherwise, in response to determination that the three-phase charging control request has occurred (NO in step S35), the charging/discharging control routine proceeds to step S38.

In step S38, the control device 100 controls each of the first and second bypass switches 181 and 182 to be off.

During execution of the three-phase charging control in which power imbalance to be unlikely to occur so that it is unnecessary to increase the capacitance of the smoothing capacitor, the control device 100 of the third embodiment reduces, like the second embodiment, loss resulting from the power conversion device 10 of the third embodiment.

### Modifications of Fourth Embodiment

The control device 100 according to a modification of the fourth embodiment may be configured not to perform the operations in steps S35 and S38 in FIG. 16. That is, the control device 100 according to this modification of the fourth embodiment may maintain each of the first and second bypass switches 181 and 182 in the on state while performing the three-phase charging control.

### Fifth Embodiment

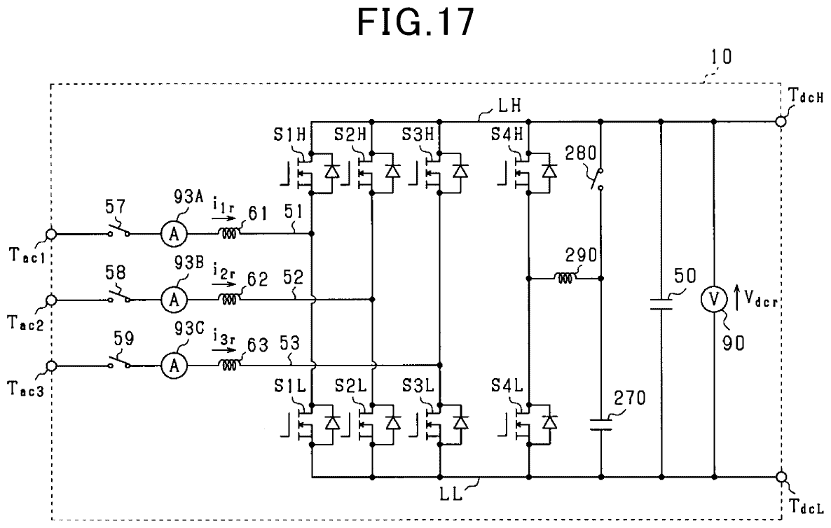

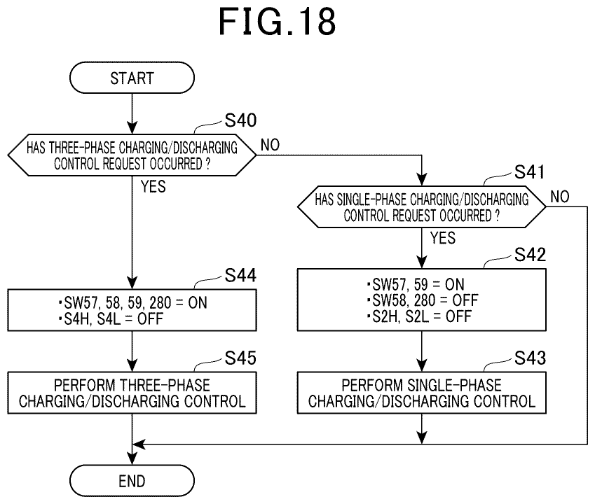

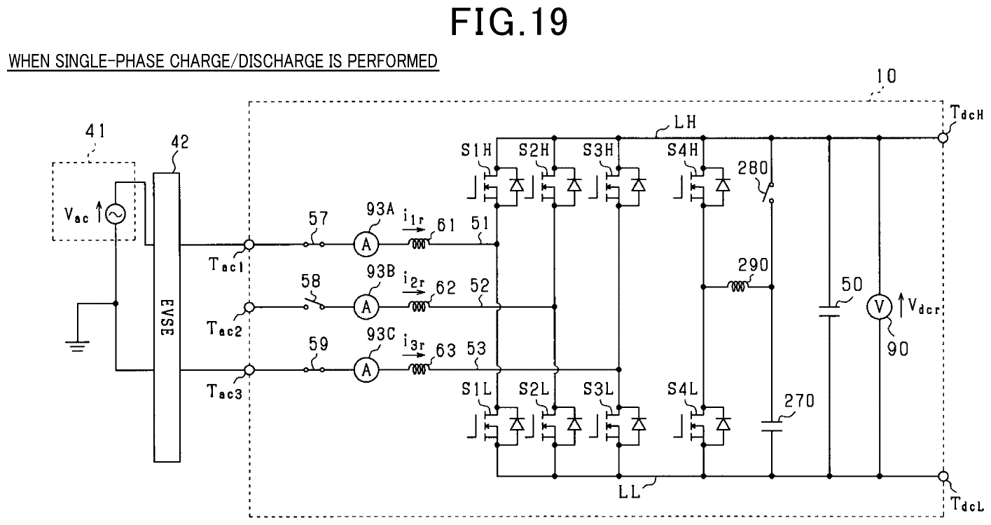

The following describes a fifth embodiment with reference to FIGS. 17 and 18 while focusing on the differences of the fifth embodiment from the first embodiment.

In the present embodiment, as illustrated in FIG. 17, the power conversion device 10 of the fifth embodiment does not include, for example, the connection path 54, the first single-phase charge switch 55, the second single-phase charge switch 56, the bypass switch 80, and the fourth AC terminal Tac4.

The power conversion device 10 of the fifth embodiment includes, as a configuration for ripple reduction, the fourth upper and lower arm switches S4H, S4L, a compensating capacitor 270, and a compensating inductor 290. The connection point between the fourth upper and lower arm switches S4H and S4L is connected to a first terminal of the compensating inductor 290. A second terminal of the compensating inductor 290 is connected to a first terminal of the compensating capacitor 270, and a second terminal of the compensating capacitor 270 is connected to the low-potential side path LL.

The power conversion device 10 of the fifth embodiment includes, as a configuration for selecting whether the compensating capacitor 270 is connected in parallel to the DC side capacitor 50, a bypass switch 280. Turning on the bypass switch 280 causes the compensating capacitor 270 to be connected in parallel to the DC side capacitor 50. When being in the on state, the bypass switch 280 enables bidirectional current flow therethrough. When being in the off state, the bypass switch 280 prevents bidirectional current flow therethrough.

FIG. 18 is a flowchart illustrating the charging/discharging control routine to be carried out by the control device 100 according to the fifth embodiment. In FIG. 18, operations in steps S40 and S41 are identical to those in steps S10 and S11 in FIG. 3.

In response to determination that the single-phase charging control request or the single-phase discharging control request has occurred (YES in step S41), the charging/discharging control routine proceeds to step S42.

In step S42, the control device 100 controls the second interrupting switch 58 to be off, and controls each of the first interrupting switch 57 and the third interrupting switch 58 to be on. Additionally, the control device 100 controls each of the bypass switch 280 and the second upper and lower arm switches S2H and S2L to be off.

Following the operation in step S42, the control device 100 performs the single-phase charging control or the single-phase discharging control corresponding to the single-phase charging control request or the single-phase discharging control request in step S43.

The following describes the single-phase charging control first.

The single-phase charging control performs switching control of each of the first upper arm switch S1H, the first lower arm switch S1L, the third upper arm switch S3H, and the third lower arm switch S3L to accordingly convert the AC power input from the first AC terminal Tac1 and the third AC terminal Tac3 into DC power, thus outputting the DC power from the high-potential side DC terminal TdcH and the low-potential side DC terminal TdcL.

Specifically, the single-phase charging control alternately turns on the upper and lower arm switches in each phase in synchronization with one another with a dead time interposed between their on and off operations. In each phase, the switching period of the upper and lower arm switches is the same.

In addition, the single-phase charging control performs switching control of each of the fourth upper arm switch S4H and the fourth lower arm switch S4L to accordingly reduce ripple in the DC power output from the high-potential side DC terminal TdcH and the low-potential side DC terminal TdcL.

Specifically, the single-phase charging control alternately turns on the fourth upper arm switch S4H and the fourth lower arm switch S4L with a dead time being interposed between their on and off operations. The switching period of the fourth upper and lower arm switches S4H, S4L is identical to the switching period of each of the first and third upper and lower arm switches S1H, S1L, S3H, S3L.

Next, the following describes the single-phase discharging control.

The single-phase discharging control performs switching control of each of the first upper arm switch S1H, the first lower arm switch S1L, the third upper arm switch S3H, and the third lower arm switch S3L to accordingly convert DC power input from the high-potential side DC terminal TdcH and the low-potential side DC terminal TdcL into AC power, thus outputting the AC power from the first AC terminal Tac1 and the third AC terminal Tac3.

Specifically, the single-phase discharging control alternately turns on the upper and lower arm switches in each phase in synchronization with one another with a dead time interposed between their on and off operations. In each phase, the switching period of each of the upper and lower arm switches is the same.

Otherwise, in response to determination that the three-phase charging control request or the three-phase discharging control request has occurred (YES in step S40), the charging/discharging control routine proceeds to step S44.

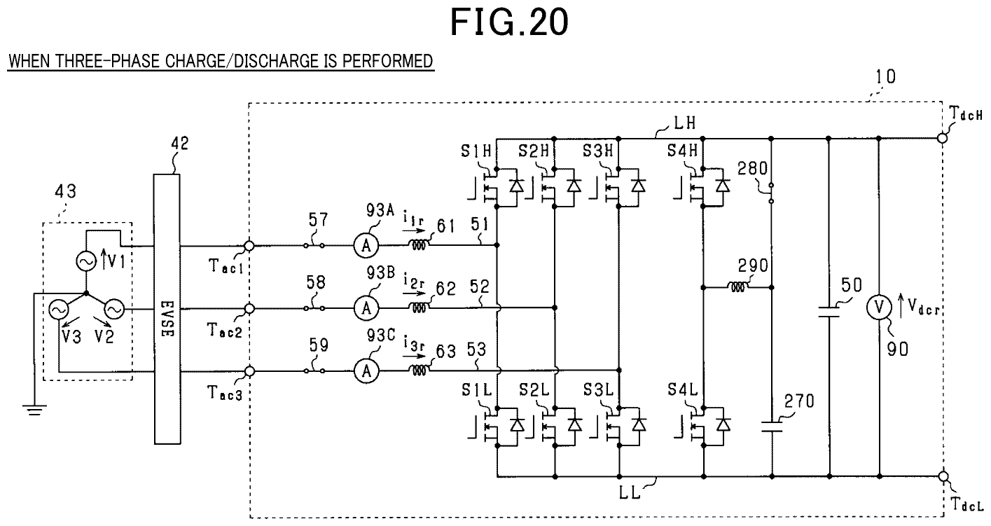

In step S44, the control device 100 controls each of the first interrupting switch 57, the second interrupting switch 58, and the third interrupting switch 59 to be on, and controls each of the fourth upper and lower arm switches S4H and S4L to be off (see FIG. 20).

Additionally, the control device 100 controls the bypass switch 280 to be on to accordingly connect the compensating capacitor 270 in parallel to the DC side capacitor 50 in step S44.

Following the operation in step S44, the control device 100 performs the three-phase charging control or the three-phase discharging control corresponding to the three-phase charging control request or the three-phase discharging control request in step S45.
The following describes the three-phase charging control first.

The three-phase charging control performs switching control of each of the first, second, and third upper arm switches S1H, S2H, S3H and the first, second, and third lower arm switches S1L, S2L, S3L to accordingly convert the three-phase AC power input from the first AC terminal Tac1, the second AC terminal Tac2, and the third AC terminal Tac3 into DC power, thus outputting the DC power from the high-potential side DC terminal TdcH and the low-potential side DC terminal TdcL.

Next, the following describes the three-phase discharging control.

The three-phase discharging control performs switching control of the first, second, and third upper arm switches S1H, S2H, S3H and the first, second, and third lower arm switches S1L, S2L, S3L to accordingly convert DC power input from the high-potential side DC terminal TdcH and the low-potential side DC terminal TdcL into three-phase AC power, thus outputting the three-phase AC power from the first AC terminal Tac1, the second AC terminal Tac2, and the third AC terminal Tac3.

Each of the three-phase charging control and three-phase discharging control alternately turns on the upper and lower arm switches in each phase with a dead time interposed between their on and off operations. In each phase, the switching period of the upper and lower arm switches is the same.

The fifth embodiment achieves advantageous effects identical to those achieved by the first embodiment.

### Modifications

The above embodiments may be modified as below.

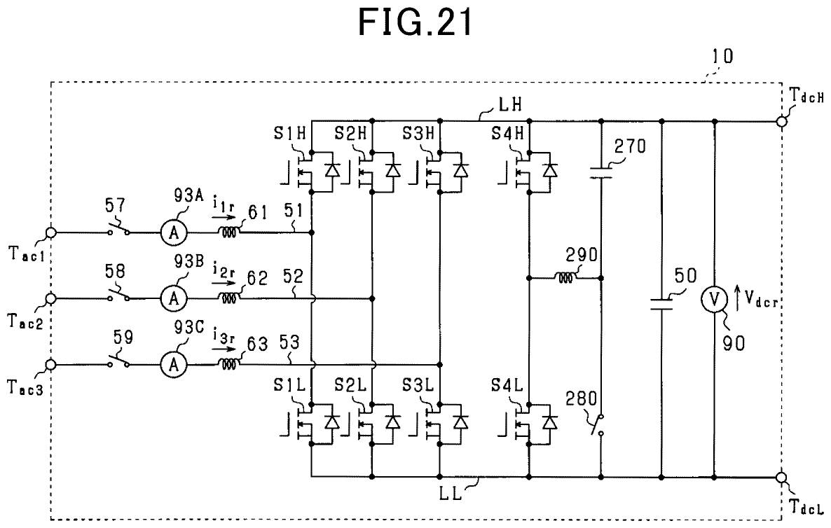

In the configuration illustrated in FIG. 17 of the fifth embodiment, the locations of the bypass switch 280 and the compensating capacitor 270 may be reversed as illustrated in FIG. 21.

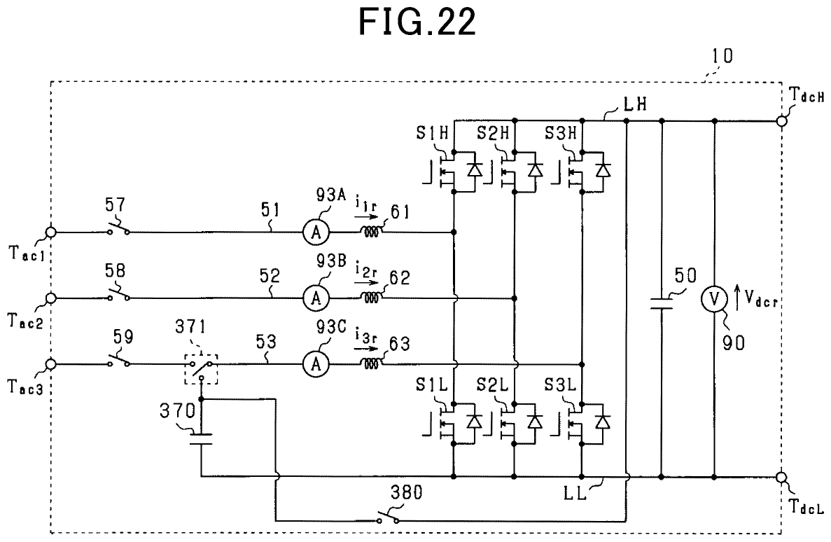

The power conversion device 10 illustrated in FIG. 17 may not include the fourth upper and lower arm switches S4H, S4L, the compensating capacitor 270, the bypass switch 280, and the compensating inductor 290. In this modification, as the configuration for ripple reduction, as illustrated in FIG. 22, the power conversion device 10 may include a compensating capacitor 370, a bypass switch 380, and a selector switch 371. A first terminal of the compensating capacitor 370 is connected with the high-potential side path LH via the bypass switch 380. A second terminal of the compensating capacitor 370 is connected with the low-potential side path LL. The selector switch 371 connects a terminal of the third inductor 63 to any of the first terminals of the second interrupting switch 58 and the compensating capacitor 370.

The control device 100 is configured to control, in the single-phase charging control or the single-phase discharging control, each of the second interrupting switch 58, the bypass switch 380, and the second upper and lower arm switches S2H, S2L to be off, and controls the first interrupting switch 57 to be on. In addition, the control device 100 operates the selector switch 371 so as to connect a terminal of the third inductor 63 to the first terminal of the compensating capacitor 370.

The control device 100 is configured to control, in the single-phase charging control, switching control of the first upper and lower arm switches S1H, 21L and the second upper and lower arm switches S2H, S2L to accordingly convert AC power input from the first AC terminal Tac1 and the second AC terminal Tac2 into DC power, thus outputting the DC power from the high-potential side DC terminal TdcH and the low-potential side DC terminal TdcL. The single-phase charging control alternately turns on the upper and lower arm switches in each phase in synchronization with one another with a dead time interposed between their on and off operations.

In addition, the single-phase charging control performs switching control of each of the third upper arm switch S3H and the third lower arm switch S3L to accordingly reduce ripple in the DC power output from the high-potential side DC terminal TdcH and the low-potential side DC terminal TdcL.

Specifically, the single-phase charging control alternately turns on the third upper arm switch S3H and the third lower arm switch S3L with a dead time being interposed between their on and off operations.

The single-phase discharging control performs switching control of each of the first upper arm switch S1H, the first lower arm switch S1L, the second upper arm switch S2H, and the second lower arm switch S2L to accordingly convert DC power input from the high-potential side DC terminal TdcH and the low-potential side DC terminal TdcL into AC power, thus outputting the AC power from the first AC terminal Tac1 and the second AC terminal Tac2.

Specifically, the single-phase discharging control alternately turns on the upper and lower arm switches in each phase in synchronization with one another with a dead time interposed between their on and off operations.

The control device 100 is configured to control, in the three-phase charging control or the three-phase discharging control, the first interrupting switch 57, the second interrupting switch 58, and the third interrupting switch 59 to be on. In addition, the control device 100 is configured to operate, in the three-phase charging control or the three-phase discharging control, the selector switch 371 so as to connect a terminal of the third inductor 63 to the third interrupting switch 59. The control device 100 is configured to control, in the three-phase charging control or the three-phase discharging control, the bypass switch 380 to be on. This enables the compensating capacitor 370 to be connected in parallel to the DC side capacitor 50.

The control device 100 is configured to perform, in the three-phase charging control, switching control of each of the first, second, and third upper arm switches S1H, S2H, S3H and the first, second, and third lower arm switches S1L, S2L, S3L to accordingly convert the three-phase AC power input from the first AC terminal Tac1, the second AC terminal Tac2, and the third AC terminal Tac3 into DC power, thus outputting the DC power from the high-potential side DC terminal TdcH and the low-potential side DC terminal TdcL.

The control device 100 is configured to perform, in the three-phase discharging control, switching control of the first, second, and third upper arm switches S1H, S2H, S3H and the first, second, and third lower arm switches S1L, S2L, S3L to accordingly convert DC power input from the high-potential side DC terminal TdcH and the low-potential side DC terminal TdcL into three-phase AC power, thus outputting the three-phase AC power from the first AC terminal Tac1, the second AC terminal Tac2, and the third AC terminal Tac3.

The first upper arm switch may be comprised of a parallel connection of a plurality of N-channel MOSFETs. Each of the first lower arm switch and the second to fourth upper and lower arm switches may have the configuration similar to that of the first upper arm switch.

Each of the upper and lower arm switches is not limited to an N-channel MOSFET and may be, for example, comprised of an IGBT in which a free wheel diode is connected in antiparallel thereto. In this modification, the collector of the IGBT corresponds to the high-potential side terminal, and the emitter of the IGBT corresponds to the low-potential side terminal.

A chargeable and dischargeable storage battery having a relatively low capacity can be used in place of each of the DC side capacitor and the compensating capacitor.

The power storage unit connected to the output part of the DC-DC converter is not limited to a storage battery and may be, for example, an electric double layer capacitor having a high capacity or both of the storage battery and the electric double layer capacitor.

For example, in the first embodiment, when the single-phase charge control is performed, the control device 100 may subject the first and second upper and lower arm switches S1H, S1L, S2H, S2L to interleave drive. The interleave drive is switching control that displaces the switching timing, at which the first upper arm switch S1H is turned on, and the switching timing, at which the second upper arm switch S2H is turned on, an electrical angle of 180° with respect to each other.

The movable body to which the power conversion device is mounted is not limited to a vehicle and may be, for example, an aircraft or a boat. In addition, the power conversion device may not be mounted to a movable body but may be a stationary device.

The power conversion device may not be able to correspond to a three-phase AC power supply and a three-phase AC load but may be able to correspond to a four or more-phase AC power supply and a four or more-phase AC load.

The control unit and the processing thereof described in the present disclosure may be implemented by a dedicated computer that is provided by configuring a processor and a memory that are programmed to execute one or more functions embodied by a computer program. Alternatively, the control unit and the processing thereof described in the present disclosure may be implemented by a dedicated computer that is provided by configuring a processor with one or more dedicated hardware logic circuits. Alternatively, the control unit and the processing thereof described in the present disclosure may be implemented by one or more dedicated computers that are configured by combining a processor and a memory that are programmed to execute one or more functions, with a processor that is configured by one or more hardware logic circuits. Furthermore, the computer program may be stored in a computer readable non-transitory tangible storage medium, as instructions to be executed by a computer.

The present disclosure has so far been described based on embodiments. However, the present disclosure should not be construed as being limited to these embodiments or the structures. The present disclosure should encompass various modifications, and modifications within the range of equivalence. In addition, various combinations and modes, as well as other combinations and modes, including those which include one or more additional elements, or those which include fewer elements should be construed as being within the scope and spirit of the present disclosure.

1. A power conversion device comprising:
multiphase AC terminals;
a pair of a high-side DC terminal and a low-side DC terminal, the power conversion device being configured such that one of a multiphase AC unit for supplying multiphase alternating currents and a single-phase AC unit for supplying a single-phase alternating current is connectable to at least one of the multiphase AC terminals;
upper and lower arm switches provided for each phase and connected to one another, the upper arm switch having a high-side terminal, the lower arm switch having a low-side terminal;
a high-side path connecting the high-side terminal of each upper arm switch and the high-side DC terminal;
a low-side path connecting the low-side terminal of each lower arm switch and the low-side DC terminal;
a DC side power storage unit connecting the high-side path and the low-side path;
electric paths provided for the respective phases, each of the electric paths being arranged to connect between a connection point of the upper and lower arm switches of the corresponding phase and the AC terminal of the corresponding phase;
inductors, each of which is provided to the corresponding one of the electric paths;
a compensating power storage unit configured to, when the single-phase AC unit is connected to at least one of the multiphase AC terminals, reduce ripple in a direct current outputted from the high- and low-side DC terminals; and
a bypass switch configured to select whether the compensating power storage unit is connected in parallel to the DC side power storage unit.

2. The power conversion device according to claim 1, wherein:
the multiphase AC terminals include a first AC terminal, a second AC terminal, a third AC terminal, and a fourth AC terminal;
the power conversion device is configured such that a three-phase AC unit as the multiphase AC unit is connectable to the first, second, and third AC terminals, and the single-phase AC unit is connectable to the first AC terminal and the fourth AC terminal;
the upper and lower arm switches include:
a first upper arm switch and a first lower arm switch connected to one another;
a second upper arm switch and a second lower arm switch connected to one another; and
a third upper arm switch and a third lower arm switch connected to one another;
the electric paths include:
a first path arranged to connect between the connection point of the first upper and lower arm switches and the first AC terminal;
a second path arranged to connect between the connection point of the second upper and lower arm switches and the second AC terminal; and
a third path arranged to connect between the connection point of the third upper and lower arm switches and the third AC terminal;
the inductors include:
a first inductor provided to the first path;
a second inductor provided to the second path; and
a third inductor provided to the third path,
the power conversion device further comprising:
fourth upper and lower arm switches connected to one another, the fourth upper arm switch having a high-side terminal, the fourth lower arm switch having a low-side terminal;
a connection path;
a single-phase charge switch provided to the connection path; and
a compensating switch;
the high-side terminal of the fourth upper arm switch is connected to the high-side path;
the low-side terminal of the fourth lower arm switch is connected to the low-side path;
the connection path is arranged to connect between a connection point of the fourth upper and lower arm switches and the fourth AC terminal;
the compensating power storage unit has opposite first and second terminals, the first terminal of the compensating power storage unit being connected to a portion of the third path through the compensating switch, the portion of the third path being located closer to the third AC terminal than the third inductor is;
the second terminal of the compensating power storage unit is connected to one of the low-side path and the high-side path; and
a connection point between the compensating power storage unit and the compensating switch is connected to the other of the low-side path and the high-side path through the bypass switch.

3. The power conversion device according to claim 2, wherein:
the DC side power storage unit has a capacitance lower than that of the compensating power storage unit.

4. The power conversion device according to claim 2, further comprising a control unit, wherein:
the control unit is configured to:
control each of the single-phase charge switch and the compensating switch to be on and control the bypass switch to be off in response to determination that the single-phase AC unit is connected to the first and fourth AC terminals; and
control each of the single-phase charge switch and the compensating switch to be off and control the bypass switch to be on in response to determination that the three-phase AC unit is connected to the first, second, and third AC terminals.

5. The power conversion device according to claim 4, wherein:
the control unit is configured to:
control each of the single-phase charge switch and the compensating switch to be off and control the bypass switch to be on in response to determination that:
the three-phase AC unit is connected to the first, second, and third AC terminals; and
there is a first situation where the power conversion device converts first DC power input from the high- and low-side DC terminals into first three-phase AC power and outputs the first three-phase AC power from the first, second, and third AC terminals; and
control each of the single-phase charge switch, the compensating switch, and the bypass switch to be off in response to determination that:
the three-phase AC unit is connected to the first, second, and third AC terminals; and
there is a second situation where the power conversion device converts second three-phase AC power input from the first, second, and third AC terminals into second DC power and outputs the second DC power from the high- and low-side DC terminals.

6. A computer-program product applicable to a power conversion device that comprises:
first to fourth AC terminals;
a pair of a high-side DC terminal and a low-side DC terminal; and
a computer,
the power conversion device being configured such that a three-phase AC unit for supplying three-phase alternating currents is connectable to the first, second, and third AC terminals and a single-phase AC unit for supplying a single-phase alternating current is connectable to the first and fourth AC terminals,
the power conversion device further comprising:
a first upper arm switch and a first lower arm switch connected to one another;
a second upper arm switch and a second lower arm switch connected to one another;
a third upper arm switch and a third lower arm switch connected to one another;
a fourth upper arm switch and a fourth lower arm switch connected to one another;
a high-side path connecting the high-side terminal of each upper arm switch and the high-side DC terminal;
a low-side path connecting the low-side terminal of each lower arm switch and the low-side DC terminal;
a DC side power storage unit connecting the high-side path and the low-side path;
a first path arranged to connect between the connection point of the first upper and lower arm switches and the first AC terminal;
a second path arranged to connect between the connection point of the second upper and lower arm switches and the second AC terminal;
a third path arranged to connect between the connection point of the third upper and lower arm switches and the third AC terminal;
a first inductor provided to the first path;
a second inductor provided to the second path;
a third inductor provided to the third path;
a compensating power storage unit;
a connection path;
a single-phase charge switch provided to the connection path;
a compensating switch; and
a bypass switch,
the high-side terminal of the fourth upper arm switch being connected to the high-side path,
the low-side terminal of the fourth lower arm switch being connected to the low-side path,
the connection path being arranged to connect between a connection point of the fourth upper and lower arm switches and the fourth AC terminal,
the compensating power storage unit having opposite first and second terminals, the first terminal of the compensating power storage unit being connected to a portion of the third path through the compensating switch, the portion of the third path being located closer to the third AC terminal than the third inductor is,
the second terminal of the compensating power storage unit being connected to one of the low-side path and the high-side path,
a connection point between the compensating power storage unit and the compensating switch being connected to the other of the low-side path and the high-side path through the bypass switch,
the computer-program product comprising:
a non-transitory storage medium; and
program instructions stored in the non-transitory storage medium,
the program instructions causing the computer to:
control each of the single-phase charge switch and the compensating switch to be on and control the bypass switch to be off in response to determination that the single-phase AC unit is connected to the first and fourth AC terminals; and
control each of the single-phase charge switch and the compensating switch to be off and control the bypass switch to be on in response to determination that the three-phase AC unit is connected to the first, second, and third AC terminals.
